(19) United States
(12) Patent Application Publication
(10) Pub. No.: US 2013/0058074 A1
(43) Pub. Date: Mar. 7, 2013

(54) HANDRAIL WITH ILLUMINATION FUNCTION

(71) Applicants: Junichi SOMEI, Osaka (JP); Toshiharu Seko, Osaka (JP)

(72) Inventors: Junichi SOMEI, Osaka (JP); Toshiharu Seko, Osaka (JP)

(21) Appl. No.: 13/559,645

(22) Filed: Jul. 27, 2012

(30) Foreign Application Priority Data
Sep. 5, 2011 (JP) 2011-193196

(51) Int. Cl. F21S 8/00

(52) U.S. Cl. 362/145

(57) ABSTRACT

A handrail with an illumination function includes: a handrail main body; a decorative cover that is disposed at part of the handrail main body so as to extend along a longitudinal direction of the handrail main body and has a light transmitting property; a flatter that is disposed on an inner side with respect to the decorative cover so as to extend along the longitudinal direction of the handrail main body and reflects and diffuses light to radiate the light through a slit; and a light source that is disposed on an inner side of the flatter.

This application is based on Japanese Patent Application No. 2011-193196 filed on Sep. 5, 2011, the contents of which are hereby incorporated by reference.

### BACKGROUND OF THE INVENTION

1. Field of the Invention

The present invention relates to a handrail with an illumination function.

2. Description of the Related Art

Typically, stairs, corridors, and so on in buildings are provided with handrails for the sake of pedestrians' safety. In a dark place without a light source, such as at night, however, a handrail might not be able to fulfill its role since the presence thereof can hardly be recognized.

In order that the presence of a handrail can be easily recognized even in a dark place, it is required that a light source be installed to illuminate the handrail or that the handrail itself be designed to emit light. From this viewpoint, there has been proposed a handrail that is provided with an illumination function so that the handrail can be easily recognized even in a dark place such as at night and so that a feet area can be illuminated to secure safety.

Prior art techniques related to a handrail product having an illumination function are described in, for example, Conventional Examples 1 to 5 below.

As shown in FIG. 31, a handrail with an illumination function described in Conventional Example 1 (JP-A-2010-70962) includes a cylindrical handrail main body 311 molded of a transparent or semitransparent resin, a cylindrical member 312, an illumination unit disposed inside the handrail main body 311, and an end cap 313 mounted to each of both ends of the handrail main body 311 to fix these components, thus having a predetermined degree of strength as a handrail.

Furthermore, the handrail with an illumination function described in Conventional Example 1 has the illumination unit that includes the cylindrical member 312 formed by assembling two semicylindrical members together, a light source body 314 disposed at each of end portions of the cylindrical member, and an end face member 315 disposed at each of both ends of the cylindrical member 312 and having a wiring section for connection to the light source body 314, and since a wiring board is not used, irradiation in 360 degree directions can be achieved. In addition to that, since the end cap 313 is molded of a transparent or semitransparent resin and has an end face having a lens function, irradiation from both ends of the handrail also can be achieved.

Furthermore, as shown in FIG. 32, Conventional Example 2 (JP-A-2009-218145) discloses an indoor handrail 321 together with an auxiliary illumination fixture that illuminates a pedestrian's feet area and the vicinity thereof along the handrail. In this configuration, a base board 322 is fixedly retrofitted to a wall surface of a building parallel to the existing handrail 321 so that simultaneous illumination in two different directions, i.c. in a direction of the existing handrail 321 and in a direction of the feet area of the walking pedestrian can be achieved through light emission by an LED 325 fixed to each of first and second LED wiring boards 323 and 324. The auxiliary illumination fixture is applicable to various types of existing handrails and thus is versatile. Furthermore, in a case where the LED 325 as a luminous body is set to be turned on automatically in receipt of a detection output signal of a human body detection sensor, the need for an artificial operation of switching it on and off is eliminated.

It is explained that, when formed of a synthetic resin into which a light storing material is mixed, a concealing decorative cover 326 stores light, thereby making it possible to secure walking safety in the event of a power failure. The fact is, however, that light thus stored is used for irradiation immediately, so that it is impossible to secure long-time irradiation in the event of a power failure.

Furthermore, as shown in FIG. 33, Conventional Example 3 (JP-A-2006-045817) discloses a handrail with an illumination function that has a handrail main body 331 and a bracket 332 that houses an illumination unit therein, has an installation surface, and supports the handrail main body 331. The bracket 332 is provided with a human body detection unit 333 that detects an approaching human and a unit that promotes illumination in response to such detection.

Furthermore, it is explained that the above-described handrail may be configured as follows. That is, driving of the illumination unit is started at predetermined timing after a lapse of a predetermined length of time from the time of detection by the human body detection unit 333, which is measured by use of a measurement unit such as a timer. Further, in a case where an illuminance sensor 334 capable of detecting brightness in the surroundings is provided, driving of the illumination unit is started when an illuminance level detected by the illuminance sensor 334 reaches a predetermined value.

Furthermore, in a case where the bracket 332 is a resinous body having a light storing property, even after illumination has been turned off, the bracket 332 itself can be dimly seen.

Furthermore, as shown in FIG. 34, Conventional Example 4 (the publication of Japanese Patent No. 4015108) discloses a handrail with an illumination function composed of a handrail main body G formed by integrally attaching a cover tube 342 that can transmit light therethrough to a circumferential surface of an aluminum extruded tube 341 and a pair of hollow handrail brackets B1 that fixedly supports the handrail main body G. A groove rail for receiving an LED wiring board 343, which is provided inside a hollow portion of the aluminum extruded tube 341, and a linearly extending light transmission opening continuous with the groove rail, which is provided through the circumferential surface of the aluminum extruded tube 341, are arranged in rows. A plurality of LEDs 344 are installed on the LED wiring board 343 so as to be scatteredly distributed, and one such LED wiring board 343 having a longer length or a plurality of such LED wiring boards 343 having a shorter length, any adjacent ones of which are in electrical conduction with each other, are laid by being inserted into the groove rail of the aluminum extruded tube 341. One end portion of the LED wiring board(s) 343 is connected/wired to a power source through the inside of a hollow portion of one of the pair of hollow handrail brackets B1, and thus light emitted from the LEDs 344 is transmitted from the light transmission opening of the aluminum extruded tube 341 through the cover tube 342 to the outside of the handrail main body G.

Furthermore, as shown in FIGS. 35 and 36, in a handrail with an illumination function described in Conventional Example 5 (the publication of Japanese Patent No. 3962712), a bracket 352 that fixes a handrail member 351 is provided with a human detection sensor 353 or a photosensor 353, and thus the need for work to mount such a sensor to a wall surface or the like is eliminated, thereby allowing a working cost to be reduced. Furthermore, a luminous body 354 is installed in a concave groove formed on the handrail member 351 along a longitudinal direction thereof, and the bracket is provided with the sensor, so that this handrail is not limited by the material and structure of the handrail member 351.

According to the prior art technique described in Conventional Example 1 above (FIG. 31), irradiation in 360 degree directions can be achieved, and in the cylindrical member 312 constituting the illumination unit, a multitude of inner surface protrusions 312A each having an acutely angled tip end and a prism effect are arranged in a row at a predetermined spacing from each other, so that a region to be illuminated can be more uniformly illuminated with efficiency, while on an outer peripheral surface of the cylindrical member 312, a multitude of outer surface convex portions or outer surface concave portions each having a lens effect are formed so as to correspond in position to the inner surface protrusions 312A, respectively, so that an improved light diffusing effect can be obtained. The fact is, however, that since the light source body 314 is disposed only at each of the end portions of the cylindrical member 312, the cylindrical member 312 is not uniformly irradiated with light of the light source body 314, and it is therefore unlikely that the entire surface of the handrail main body 311 is uniformly irradiated. Furthermore, it is also conceived that the amount of light obtained per unit area is decreased (a resulting brightness level is low).

Furthermore, it is also explained that a predetermined amount of a light reflective substance or a light storing material may be added beforehand to a transparent or semitransparent resin used to form the cylindrical member 312 so that light can be amplified and uniformly emitted. As described above, however, light is unlikely to be uniformly emitted. Furthermore, since the cylindrical member 312 is non-uniformly irradiated with light of the light source body 314, light is unlikely to be uniformly stored, and in fact, it is conceived that light storage itself does not occur properly due to such non-uniform irradiation.

Furthermore, according to the prior art technique described in Conventional Example 2 above (FIG. 32), the auxiliary illumination fixture is fixedly retrofitted parallel to the existing handrail 321, thus requiring extra space and work for its installation. Furthermore, it is also explained that, when formed of a synthetic resin into which a light storing material is mixed, the concealing decorative cover 326 can store light. The fact is, however, that the concealing decorative cover 326 is not uniformly irradiated with light, and thus light is unlikely to be uniformly stored, which conceivably results in a poor light storing effect.

Furthermore, according to the prior art technique described in Conventional Example 3 above (FIG. 33), the bracket 332 has an illumination function that is exerted only locally, and the handrail main body 331 has no illumination function, so that irradiation light can be obtained only quite locally. Hence, it is conceived that even in the case where the bracket 332 is provided with a light storing property, irradiation light can be obtained only locally, which results also in a limited light storing effect.

Furthermore, according to the prior art technique described in Conventional Example 4 above (FIG. 34), the cover tube 342 provided adjacently to the LED wiring board(s) 343 has no particular features, and it is therefore conceived that achieving uniform irradiation from the handrail main body G requires a large number of LEDs (light sources) and power for turning on those LEDs.

Furthermore, according to the prior art technique described in Conventional Example 5 above (FIGS. 35 and 36), an opening of the concave groove in which the luminous body 354 is installed is closed with a light storing cover 355, and the light storing cover 355 emits afterglow even after light emission by the luminous body 354 has been halted. In this structure, however, the luminous body 354 is, in fact, in contact with the light storing cover 355, and thus in order for light to be uniformly stored and for afterglow to be emitted properly, it is required that a linear luminous body having the same length as that of the light storing cover 355 be installed.

### SUMMARY OF THE INVENTION

It is an object of the present invention to provide a handrail with an illumination function that is capable of applying highly uniform irradiation light to a desired area.

A handrail with an illumination function according to the present invention includes: a handrail main body; a decorative cover that is disposed at part of the handrail main body so as to extend along a longitudinal direction of the handrail main body and has a light transmitting property; a flatter that is disposed on an inner side with respect to the decorative cover so as to extend along the longitudinal direction of the handrail main body and reflects and diffuses light to radiate the light through a slit; and a light source that is disposed on an inner side of the flatter.

According to this configuration, when the light source performs light emission, the flatter radiates highly uniform light through the slit, and thus highly uniform irradiation light can be applied to a desired area through the decorative cover.

Furthermore, on the inner side with respect to the decorative cover, a light storing material extending along a longitudinal direction of the decorative cover may be provided.

Furthermore, the decorative cover may contain a light storing material or paint containing a light storing material may be applied to the decorative cover.

Furthermore, the decorative cover may be disposed at each of a plurality of locations on the handrail main body.

Furthermore, a light storing material that is disposed on the inner side with respect to the decorative cover and extends along a longitudinal direction of the decorative cover may be disposed at one or each of a plurality of locations.

Furthermore, the decorative cover that contains a light storing material or to which paint containing a light storing material is applied may be disposed at one or each of a plurality of locations.

Furthermore, a wiring board or a reflector to which the light source is fixed may be provided.

Furthermore, the light source may be disposed on one side or each of both sides of the wiring board.

Furthermore, the light source is disposed in plurality, and the number of the light sources disposed and the spacing between each pair of adjacent ones of the light sources may be determined depending on the size of the decorative cover.

Furthermore, preferably, the handrail main body has a length in the range of 200 mm to 2000 mm.

Furthermore, the shape and size of the flatter and the size and disposition of the slit may be designed in consideration of the size and disposition of the decorative cover and the number and dispositions of the light sources used.

Furthermore, preferably, the light storing material has a thickness in the range of 1 mm to 10 mm.

Furthermore, a sensor that detects a human body or a sensor that detects light may be disposed at the handrail main body, a bracket that is provided at one end portion of the handrail main body and fixedly supports the handrail main body to a wall surface or a floor surface, or a handrail main body support portion that fixedly supports the handrail main body at a lower portion thereof to a wall surface or a floor surface.

Furthermore, a timer may be disposed inside the handrail main body or inside the bracket.

Furthermore, a power circuit for supplying power to the light source may be disposed inside the handrail main body or inside a bracket that is provided at one end portion of the handrail main body and fixedly supports the handrail main body to a wall surface or a floor surface.

Furthermore, an external power circuit unit for supplying power to the light source may be connectable to the handrail with an illumination function.

Furthermore, preferably, the light source is an LED light source.

Furthermore, a plurality of the handrail main bodies may be connected via a bracket.

### DESCRIPTION OF THE DRAWINGS

FIG. 1 is a perspective view of a handrail with an illumination function according to a first embodiment of the present invention.

FIG. 2 is an exploded perspective view of the handrail with an illumination function according to the first embodiment of the present invention.

FIG. 3 is a schematic sectional side view of the handrail with an illumination function according to the first embodiment of the present invention.

FIG. 4 is a schematic sectional side view showing a radiating state of light in the handrail with an illumination function according to the first embodiment of the present invention.

FIG. 5 is a perspective view of a handrail with an illumination function according to a second embodiment of the present invention.

FIG. 6 is an exploded perspective view of the handrail with an illumination function according to the second embodiment of the present invention.

FIG. 7 is a schematic sectional side view of the handrail with an illumination function according to the second embodiment of the present invention.

FIG. 8 is a schematic sectional side view showing a radiating state of light in the handrail with an illumination function according to the second embodiment of the present invention.

FIG. 9 is a schematic sectional side view showing a light storing effect obtained in the handrail with an illumination function according to the second embodiment of the present invention.

FIG. 10 is a schematic sectional side view showing a light storing effect obtained in a handrail with an illumination function according to a third embodiment of the present invention.

FIG. 11 is a perspective view of a handrail with an illumination function according to a fourth embodiment of the present invention.

FIG. 12 is a schematic sectional side view of the handrail with an illumination function according to the fourth embodiment of the present invention.

FIG. 13 is a schematic sectional side view showing a radiating state of light in the handrail with an illumination function according to the fourth embodiment of the present invention.

FIG. 14 is a schematic sectional side view showing a light storing effect obtained in the handrail with an illumination function according to the fourth embodiment of the present invention.

FIG. 15 is a perspective view of a handrail with an illumination function according to a modified example of the fourth embodiment of the present invention.

FIG. 16 is a schematic sectional side view of a handrail with an illumination function according to a fifth embodiment of the present invention.

FIG. 17 is a schematic sectional side view showing a radiating state of light in the handrail with an illumination function according to the fifth embodiment of the present invention.

FIG. 18 is a schematic sectional side view showing a light storing effect obtained in the handrail with an illumination function according to the fifth embodiment of the present invention.

FIG. 19 is a schematic sectional side view of a handrail with an illumination function according to a sixth embodiment of the present invention.

FIG. 20 is a schematic sectional side view showing a radiating state of light in the handrail with an illumination function according to the sixth embodiment of the present invention.

FIG. 21 is a schematic sectional side view of a handrail with an illumination function according to a seventh embodiment of the present invention.

FIG. 22 is a schematic sectional side view of a handrail with an illumination function according to another embodiment based on the seventh embodiment of the present invention.

FIG. 23 is a schematic sectional side view of a handrail with an illumination function according to an eighth embodiment of the present invention.

FIG. 24 is a schematic sectional side view showing a radiating state of light in the handrail with an illumination function according to the eighth embodiment of the present invention.

FIG. 25 is a perspective view of a handrail with an illumination function according to a ninth embodiment of the present invention.

FIG. 26 is an exploded perspective view of the handrail with an illumination function according to the ninth embodiment of the present invention.

FIG. 27 is a perspective view of a handrail with an illumination function according to a modified example of the ninth embodiment of the present invention.

FIG. 28 is an exploded perspective view of a handrail with an illumination function according to a tenth embodiment of the present invention.

FIG. 29 is an exploded perspective view of a handrail with an illumination function according to a modified example of the tenth embodiment of the present invention.

FIG. 30 is a perspective view of a handrail with an illumination function according to an eleventh embodiment of the present invention.

FIG. 31 is a sectional view of a handrail with an illumination function according to Conventional Example 1.

FIG. 32 is a sectional view of an auxiliary illumination fixture according to Conventional Example 2.

FIG. 33 is a perspective view of a handrail with an illumination function according to Conventional Example 3.

FIG. 34 is a sectional view of a handrail with an illumination function according to Conventional Example 4.

FIG. 35 is a front view of a handrail with an illumination function according to Conventional Example 5.

FIG. 36 is a sectional view of the handrail with an illumination function according to Conventional Example 5.

### DESCRIPTION OF THE PREFERRED EMBODIMENTS

### First Embodiment

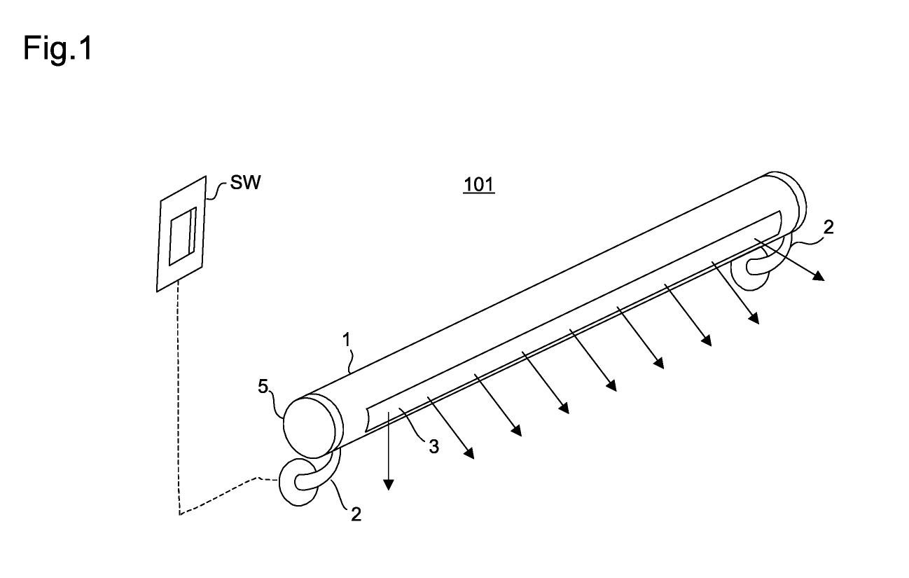

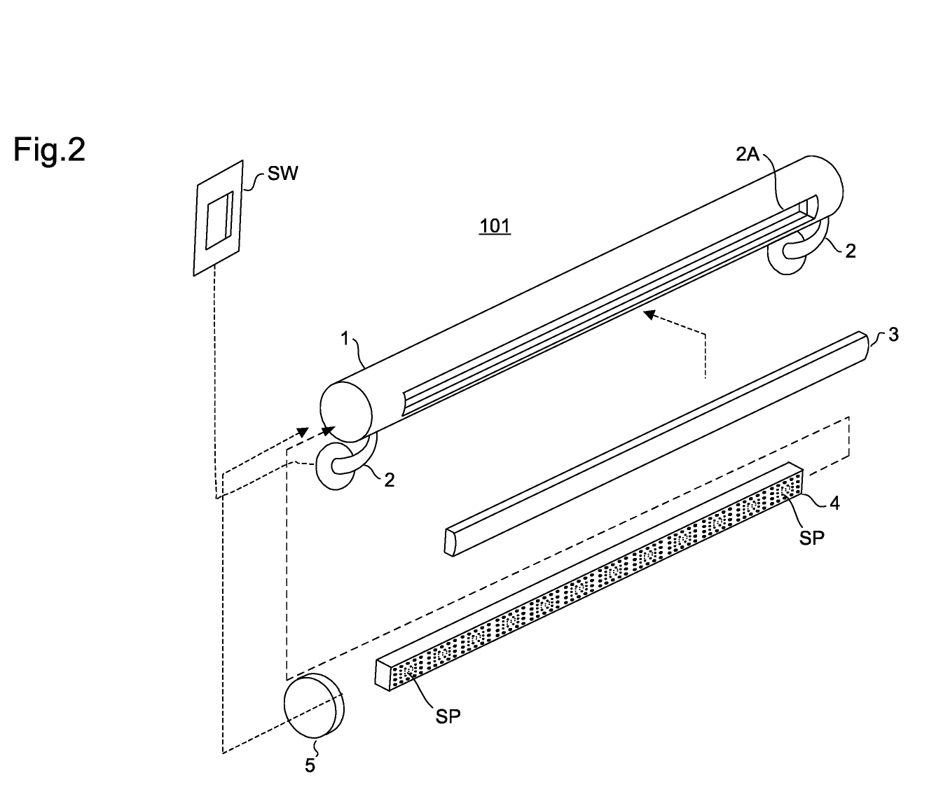

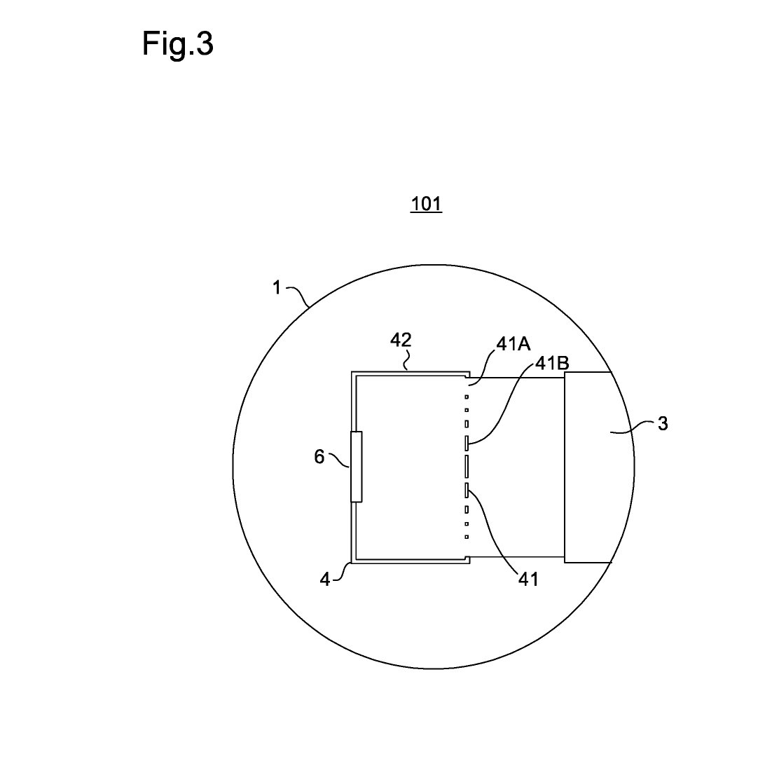

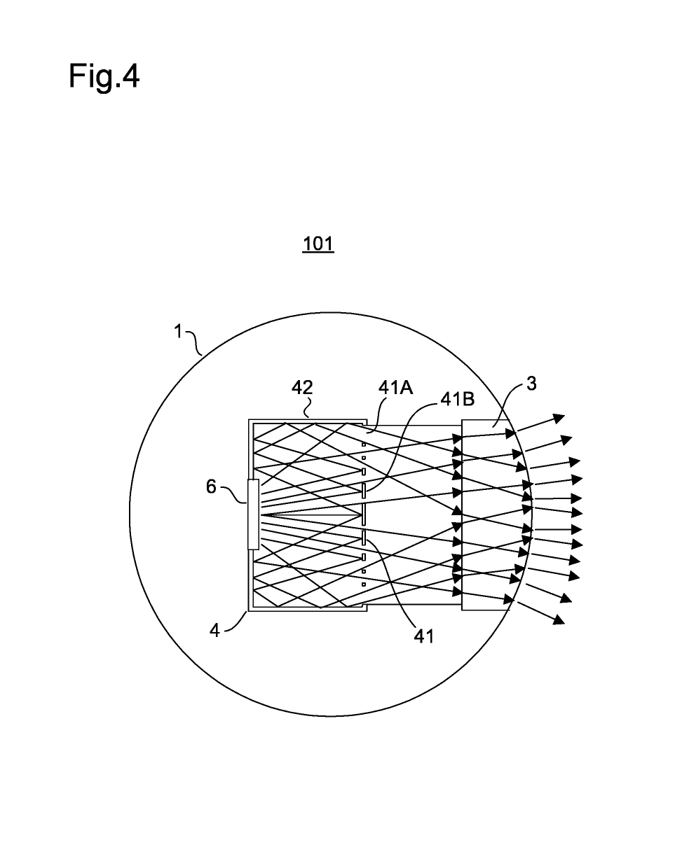

The following describes one embodiment of the present invention with reference to the appended drawings. FIG. 1 shows a perspective view of a handrail with an illumination function (hereinafter, abbreviated as an illuminant handrail) 101 according to a first embodiment of the present invention. FIG. 2 shows an exploded perspective view of the illuminant handrail 101 according to the first embodiment of the present invention. FIG. 3 shows a schematic sectional side view of the illuminant handrail 101 according to the first embodiment of the present invention. FIG. 4 shows a schematic sectional side view showing a radiating state of light in the illuminant handrail 101 according to the first embodiment of the present invention.

As shown in these figures, the illuminant handrail 101 according to the first embodiment of the present invention includes a handrail main body 1, a handrail main body support portion 2, a decorative cover 3, a flatter 4, an end cap 5, and a light source 6.

The handrail main body 1 is a member columnar in appearance and is fixedly supported at a lower portion thereof to a wall surface (for example, a wall surface in the vicinity of stairs or a corridor in a building) by the handrail main body support portion 2. The decorative cover 3 is disposed at part of the handrail main body 1 so as to extend along a longitudinal direction of the handrail main body 1 and has a light transmitting property. The flatter 4 is disposed on an inner side with respect to the decorative cover 3 so as to extend along the longitudinal direction of the handrail main body 1 and has a function of reflecting and diffusing light radiated by the light source 6 disposed on an inner side of the flatter 4 so as to radiate highly uniform irradiation light. The end cap 5 is mounted to an end portion of the handrail main body 1 after the flatter 4 with the light source 6 disposed therein is inserted into the handrail main body 1.

The handrail main body 1, the handrail main body support portion 2, and the end cap 5 are made of a material having a certain degree of strength, such as metal, hard plastic, or the like. The length of the handrail main body 1 can be determined to be optimum depending on a place of use and an intended use and, preferably, is in the range of about 200 mm to 2000 mm.

The decorative cover 3 is formed by, for example, extruding hard or semihard synthetic resin having a light transmitting property, such as an acrylic resin, an urethane resin, or the like, and is fitted into an opening portion 2A provided through the handrail main body 1.

As shown in FIG. 4, the flatter 4 is formed in a rectangular shape in appearance and is composed of a light radiation portion 41 in which a slit 41A for radiating light in a light radiation direction of the light source 6 is disposed and a reflection portion 42 that is formed to surround the light source 6 and to close five surfaces other than a surface at which the light radiation portion 41 is present and has inner side surfaces acting as reflection surfaces that reflect light. In the light radiation portion 41, the slit 41A that radiates a predetermined proportion of light from the light source 6 and a reflection portion 41B (a portion excluding the slit 41A) that reflects light from the light source 6 are provided.

The reflection portion 42 and the reflection portion 41B of the light radiation portion 41 are made of a material having a low light absorbency, and as the material, for example, particles of titanium white or polytetrafluoroethylene can be used.

In the light radiation portion 41, a plurality of slit patterns SP (see FIG. 2) each being one unit of a pattern of the slits 41A are formed in the longitudinal direction, and a plurality of the light sources 6 are provided in the longitudinal direction so as to correspond to the plurality of slit patterns SP, respectively. In each of the slit patterns SP, the slit 41A is formed to have a hole diameter increasing with increasing distance from a center portion thereof, and the reflection portion 41B that reflects light, on the other hand, is formed to have a size decreasing with increasing distance from the center portion.

Light radiated from the light source 6 is reflected and diffused, substantially without being absorbed, by the reflection portion 41B of the light radiation portion 41 and by the reflection portion 42, and is radiated to the side of the decorative cover 3 through the slit 41A of the light radiation portion 41. At this time, each of the above-described slit patterns SP allows the amount of light radiated from the light source 6 having high directivity to the center portion to be limited and the amount of light radiated therefrom to an outer side with respect to the center portion to be secured by reflection, so that highly uniform radiation light can be obtained. Light radiated from the flatter 4 is radiated to the outside through the decorative cover 3, and thus highly uniform irradiation light can be obtained. Preferably, as the light source 6 having high directivity, an LED (light emitting diode) light source is used, but there is no limitation thereto.

Wiring from an illumination switch SW (FIGS. 1 and 2) provided on the wall surface could be connected to the light source 6 through the inside of the handrail main body support portion 2.

According to the illuminant handrail 101 of the first embodiment of the present invention configured as above, highly uniform irradiation light can be applied to a desired area, and thus even in a dark place such as at night, the presence of a handrail can be easily recognized and a feet area can be easily viewed.

The number of the light sources 6 disposed in plurality and the spacing between each pair of adjacent ones of the light sources 6 could be selected and determined appropriately depending on the shapes and sizes of the flatter 4 and the decorative cover 3.

Furthermore, the illuminant handrail according to this embodiment can also be used along with an existing handrail main body support potion.

### Second Embodiment

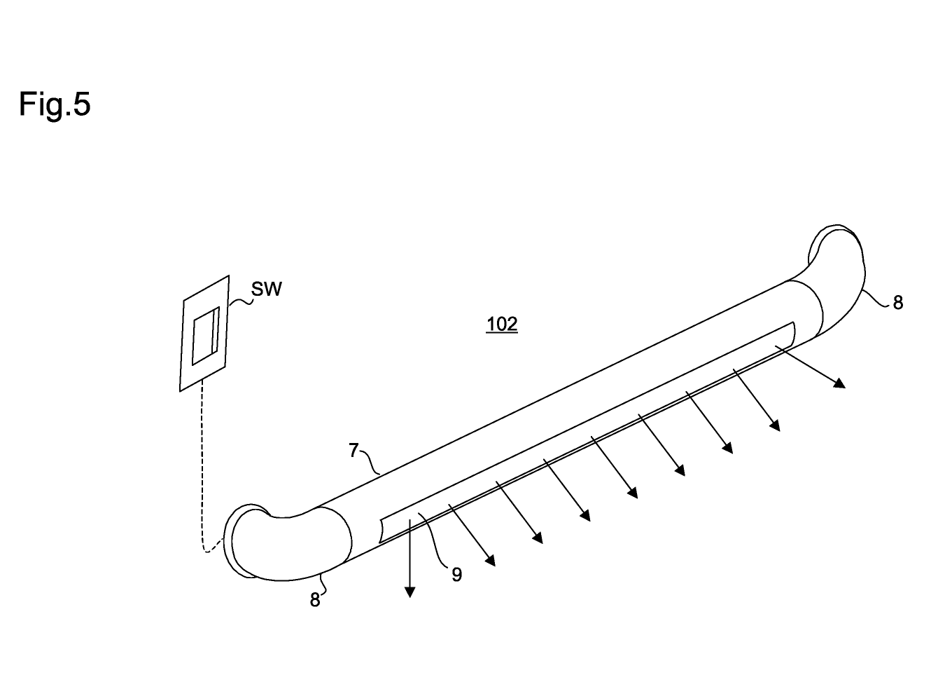

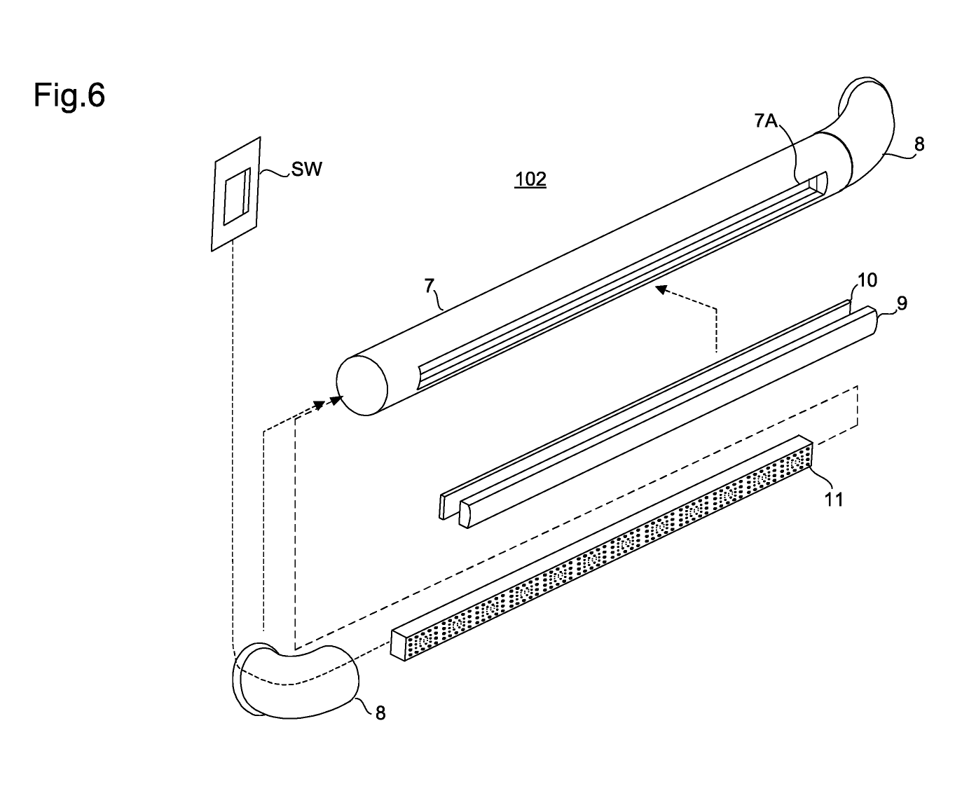

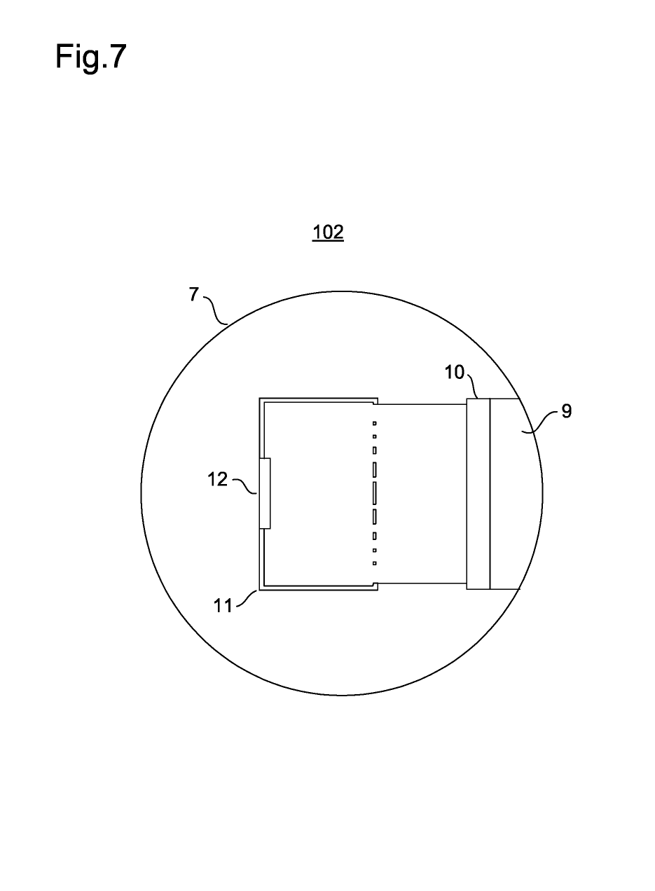

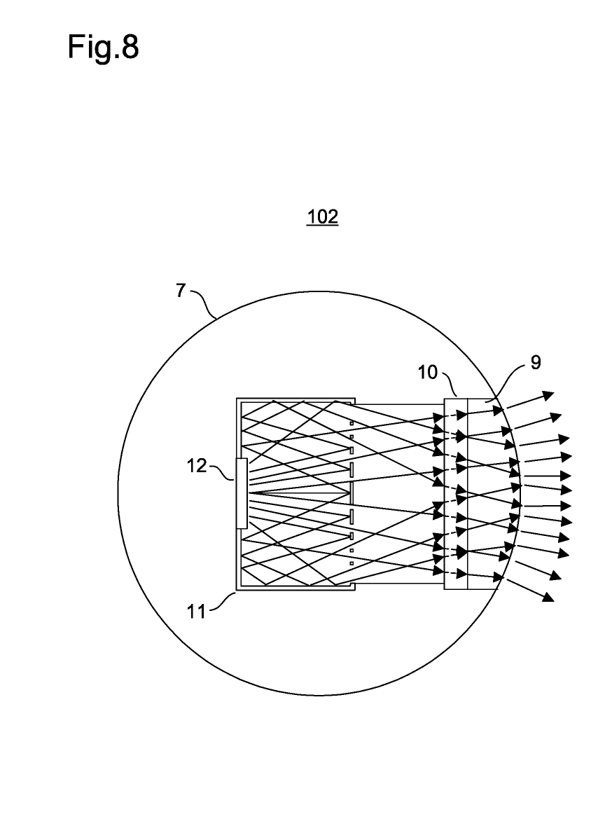

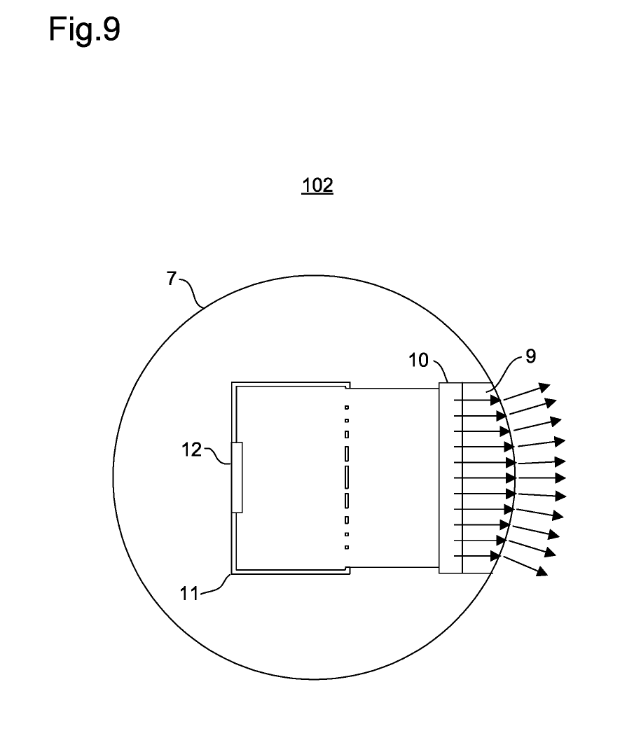

FIG. 5 shows a perspective view of an illuminant handrail 102 according to a second embodiment of the present invention. FIG. 6 shows an exploded perspective view of the illuminant handrail 102 according to the second embodiment of the present invention. FIG. 7 shows a schematic sectional side view of the illuminant handrail 102 according to the second embodiment of the present invention. FIG. 8 shows a schematic sectional side view showing a radiating state of light in the illuminant handrail 102 according to the second embodiment of the present invention. Furthermore, FIG. 9 shows a schematic sectional side view showing a light storing effect obtained in the illuminant handrail 102 according to the second embodiment of the present invention.

As shown in these figures, the illuminant handrail 102 according to the second embodiment of the present invention includes a handrail main body 7, a bracket 8, a decorative cover 9, a light storing material 10, a flatter 11, and a light source 12.

Now, the following describes in detail differences from the above-described first embodiment. The bracket 8 is mounted to each of both end portions of the handrail main body 7, and the handrail main body 7 is fixedly supported to a wall surface (for example, a wall surface in the vicinity of stairs or a corridor in a building). The bracket 8 is mounted to each of the end portions of the handrail main body 7 after the flatter 11 with the light source 12 disposed therein is inserted into the handrail main body 7.

The decorative cover 9 and the light storing material 10 both extend in a longitudinal direction of the handrail main body 7 and are fitted into an opening portion 7A provided through the handrail main body 7. The light storing material 10 is disposed on an inner side with respect to the decorative cover 9, and the flatter 11 is disposed on an inner side with respect to the light storing material 10. Preferably, the light storing material 10 has a thickness in the range of 1 mm to 10 mm, but there is no limitation thereto.

The flatter 11 has a similar structure to that of the flatter 4 used in the first embodiment and is therefore capable of radiating light radiated by the light source 12 in the form of highly uniform light. Light radiated from the flatter 11 is radiated to the outside through the light storing material 10 and the decorative cover 9, and thus highly uniform irradiation light can be obtained (FIG. 8).

Furthermore, the light storing material 10 is irradiated with highly uniform light, so that light is stored efficiently in the light storing material 10. Thus, in a case where light radiation by the light source 12 is halted, as for light stored in the light storing material 10, highly uniform radiation thereof can be performed for a long time (FIG. 9).

Wiring from an illumination switch SW (FIGS. 5 and 6) provided on the wall surface could be connected to the light source 12 through the inside of the bracket 8.

According to the illuminant handrail 102 of the second embodiment of the present invention configured as above, in a case where the illumination switch SW is on and thus the light source 12 is radiating light, highly uniform irradiation light can be applied to a desired area, so that even in a dark place such as at night, the presence of a handrail can be easily recognized and a feet area can be easily viewed. Furthermore, since the light storing material 10 is irradiated with highly uniform light, light is stored efficiently in the light storing material 10. Thus, even in a case where the illumination switch SW is turned off to halt light emission by the light source 12, light stored in the light storing material 10 is radiated, so that highly uniform irradiation light can be obtained for a long time.

The illuminant handrail according to this embodiment can also be used along with an existing bracket.

### Third Embodiment

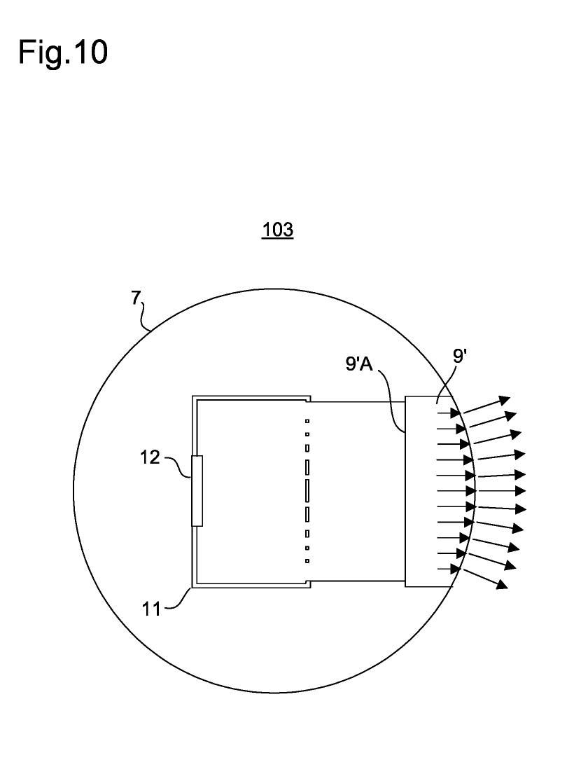

FIG. 10 shows a schematic sectional side view showing a light storing effect obtained in an illuminant handrail 103 according to a third embodiment of the present invention.

With respect to the above-described second embodiment using the light storing material 10 that is a member separate from the decorative cover 9, the illuminant handrail 103 according to this embodiment uses a decorative cover 9′ formed by, for example, extruding a resin material such as an acrylic resin, an urethane resin, or the like into which a light storing material (a light storing pigment or the like) is mixed. Alternatively, there may be used a decorative cover 9′ obtained by applying paint containing a light storing material to a light incidence surface 9′A thereof on which light from a flatter 11 becomes incident.

With this configuration, the decorative cover 9′ is irradiated with highly uniform light radiated from the flatter 11, and thus light is stored efficiently in the decorative cover 9′ containing the light storing material or in the paint containing the light storing material applied to the decorative cover 9′. Thus, as for stored light as well, uniform radiation thereof can be performed for a long time.

### Fourth Embodiment

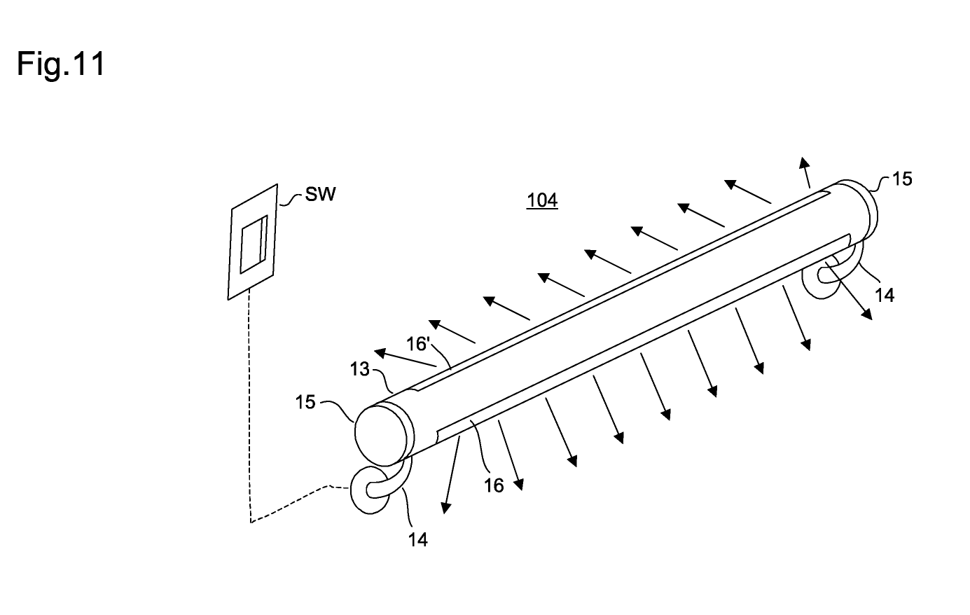

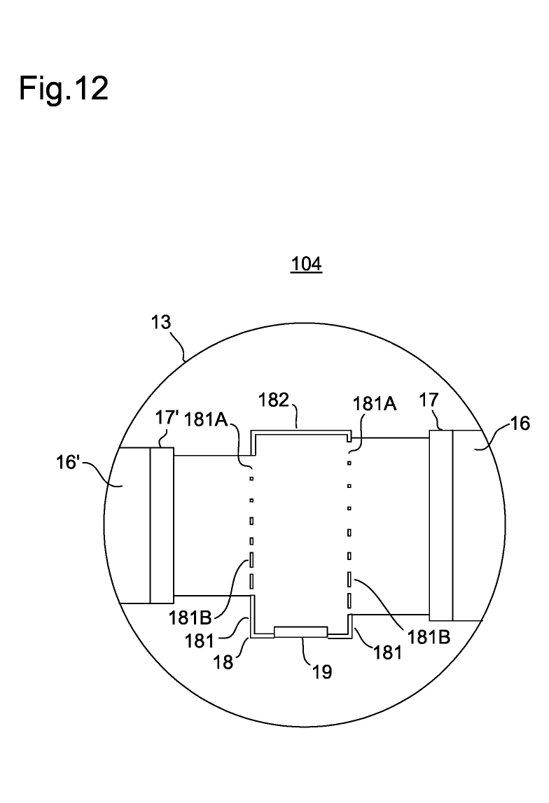

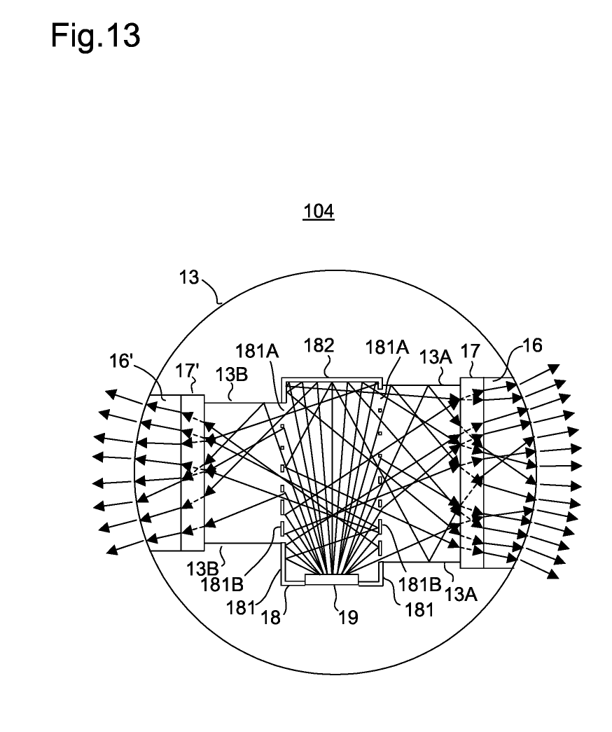

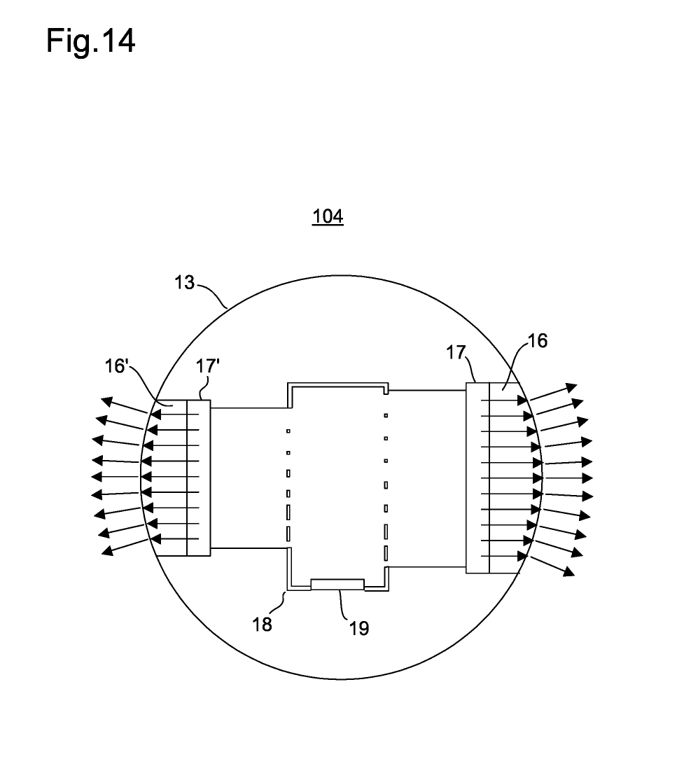

FIG. 11 shows a perspective view of an illuminant handrail 104 according to a fourth embodiment of the present invention. FIG. 12 shows a schematic sectional side view of the illuminant handrail 104 according to the fourth embodiment of the present invention. FIG. 13 shows a schematic sectional side view showing a radiating state of light in the illuminant handrail 104 according to the fourth embodiment of the present invention. Furthermore, FIG. 14 shows a schematic sectional side view showing a light storing effect obtained in the illuminant handrail 104 according to the fourth embodiment of the present invention.

As shown in these figures, the illuminant handrail 104 according to the fourth embodiment of the present invention includes a handrail main body 13, a handrail main body support portion 14, an end cap 15, decorative covers 16 and 16′, light storing materials 17 and 17′, a flatter 18, and a light source 19.

The handrail main body 13 is a member columnar in appearance and is fixedly supported to a wall surface (for example, a wall surface in the vicinity of stairs or a corridor in a building) by the handrail main body support portion 14. The two decorative covers 16 and 16′ are disposed at part of (two locations on) the handrail main body 13 so as to extend along a longitudinal direction of the handrail main body 13 and have a light transmitting property.

The light storing materials 17 and 17′ extend in the longitudinal direction of the handrail main body 13 and are disposed on an inner side with respect to the decorative covers 16 and 16′, respectively. The decorative cover 16 and the light storing material 17 as a combined set and the decorative cover 16′ and the light storing material 17′ as another combined set are fitted into opening portions provided at two locations on the handrail main body 13, respectively, so as to be disposed on sides 180° opposite to each other. Preferably, the light storing materials have a thickness in the range of 1 mm to 10 mm, but there is no limitation thereto.

The flatter 18 is disposed on an inner side with respect to the light storing materials 17 and 17′ so as to extend along the longitudinal direction of the handrail main body 13 and has a function of reflecting and diffusing light radiated by the light source 19 disposed on an inner side of the flatter 18 so as to radiate highly uniform irradiation light. The end cap 15 is mounted to each of end portions of the handrail main body 13 after the flatter 18 with the light source 19 disposed therein is inserted into the handrail main body 13.

As shown in FIG. 13, the flatter 18 is formed in a rectangular shape in appearance and is composed of light radiation portions 181 each having a slit 181A for radiating light, which are opposed to each other, and a reflection portion 182 that is formed to surround the light source 19 positioned on a bottom surface between the light radiation portions 181 and to close four surfaces other than surfaces at which the light radiation portions 181 are present and has inner side surfaces acting as reflection surfaces that reflect light. In each of the light radiation portions 181, the slit 181A that radiates light from the light source 19 and a reflection portion 181B (a portion excluding the slit 181A) that reflects light from the light source 19 are provided.

In each of the light radiation portions 181, a plurality of slit patterns each being one unit of a pattern of the slits 181A are formed in the longitudinal direction, and a plurality of the light sources 19 are provided in the longitudinal direction so as to correspond to the plurality of slit patterns, respectively.

Light radiated from the light source 19 is reflected and diffused, substantially without being absorbed, by the reflection portion 181B of each of the light radiation portions 181 and by the reflection portion 182, and is radiated to the sides of the light storing materials 17 and 17′ through the slit 181A of each of the light radiation portions 181 on both sides. Part of light radiated from the flatter 18 is reflected by upper and lower reflection surfaces 13A and 13B of the handrail main body 13 provided between the flatter 18 and each of the light storing materials 17 and 17′ and is radiated to the outside through the light storing materials 17 and 17′ and the decorative covers 16 and 16′, and thus highly uniform irradiation light can be obtained (FIG. 13).

Furthermore, the light storing materials 17 and 17′ are irradiated with highly uniform light, so that light is stored efficiently in the light storing materials 17 and 17′. Thus, in a case where light radiation by the light source 19 is halted, as for light stored in the light storing materials 17 and 17′, highly uniform radiation thereof can performed for a long time (FIG. 14).

Wiring from an illumination switch SW (FIG. 11) provided on the wall surface could be connected to the light source 19 through the inside of the handrail main body support portion 14.

According to the illuminant handrail 104 of the fourth embodiment of the present invention configured as above, in a case where the illumination switch SW is on and thus the light source 19 is radiating light, highly uniform irradiation light can be applied to a plurality of desired areas. Furthermore, since the light storing materials 17 and 17′ are irradiated with highly uniform light, light is stored efficiently in the light storing materials 17 and 17′. Thus, even in a case where the illumination switch SW is turned off to halt light emission by the light source 19, light stored in the light storing materials 17 and 17′ is radiated, so that highly uniform irradiation light can be applied to a plurality of desired areas for a long time.

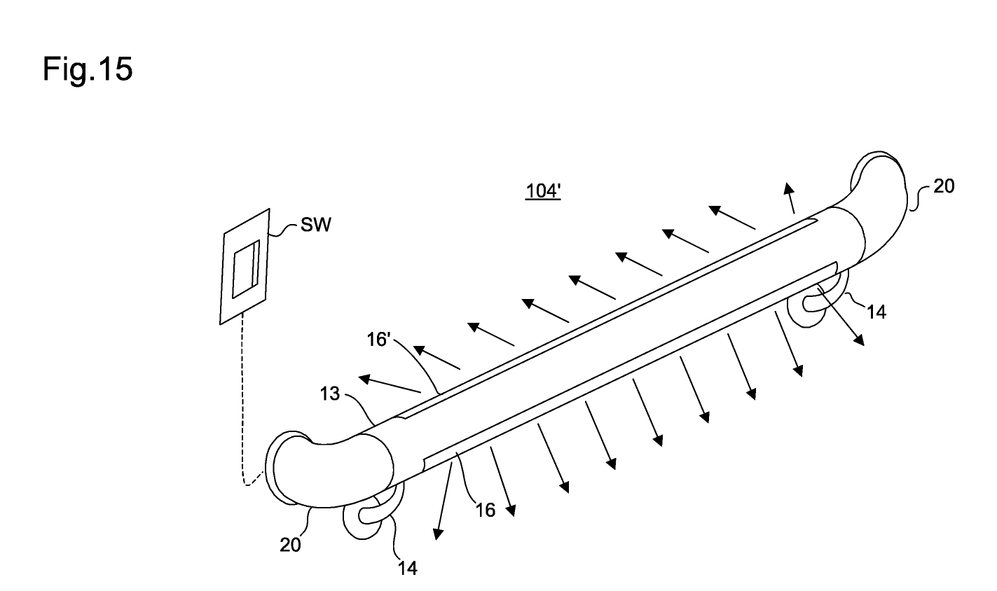

FIG. 15 shows a perspective view of an illuminant handrail 104′ according to a modified example of this embodiment. As shown in FIG. 15, with respect to the illuminant handrail 104 according to this embodiment (FIG. 11), the illuminant handrail 104′ uses a bracket 20 in place of the end cap 15. The bracket 20 is mounted to each of both end portions of the handrail main body 13 and fixedly supports the handrail main body 13 to a wall surface. Wiring from the illumination switch SW provided on the wall surface could be connected to the light source 19 through the inside of the bracket 20.

### Fifth Embodiment

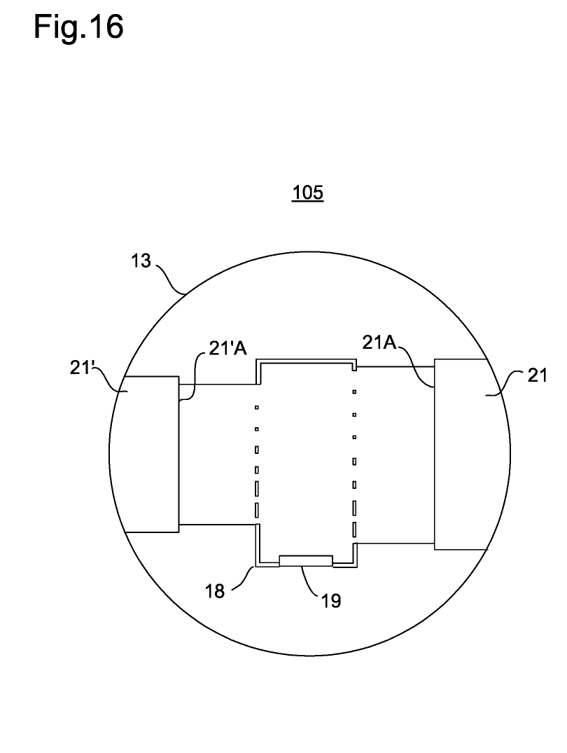

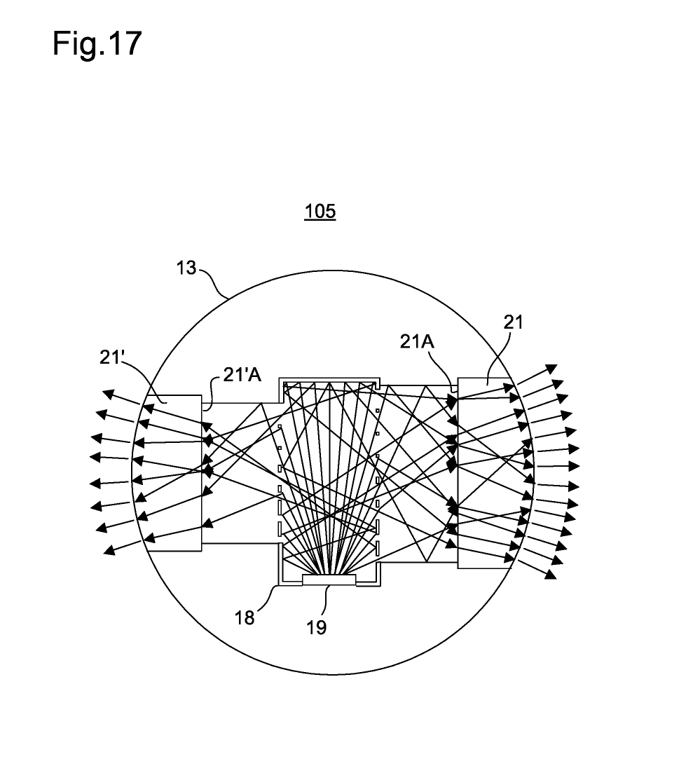

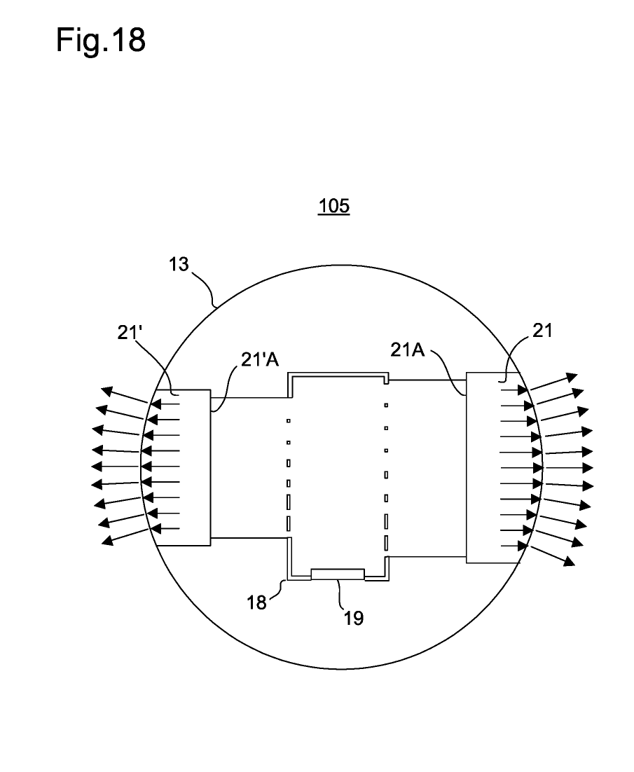

FIG. 16 shows a schematic sectional side view of an illuminant handrail 105 according to a fifth embodiment of the present invention. FIG. 17 shows a schematic sectional side view showing a radiating state of light in the illuminant handrail 105 according to the fifth embodiment of the present invention. Furthermore, FIG. 18 shows a schematic sectional side view showing a light storing effect obtained in the illuminant handrail 105 according to the fifth embodiment of the present invention.

With respect to the above-described fourth embodiment using the light storing materials 17 and 17′ that are members separate from the decorative covers 16 and 16′, the illuminant handrail 105 according to this embodiment uses decorative covers 21 and 21′ formed by, for example, extruding a resin material such as an acrylic resin, an urethane resin, or the like into which a light storing material (a light storing pigment or the like) is mixed. Alternatively, there may be used decorative covers 21 and 21′ obtained by applying paint containing a light storing material to light incidence surfaces 21A and 21A′ thereof on which light from a flatter 18 becomes incident.

With this configuration, the decorative covers 21 and 21′ are irradiated with highly uniform light radiated from the flatter 18, and thus light radiated to the outside through the decorative covers 21 and 21′ also is made highly uniform (FIG. 17).

Furthermore, since the decorative covers 21 and 21′ are irradiated with highly uniform light radiated from the flatter 18, light is stored efficiently in the decorative covers 21 and 21′ containing the light storing material or in the paint containing the light storing material applied to the decorative covers 21 and 21′. Thus, as for stored light as well, uniform radiation thereof can be performed for a long time (FIG. 18).

### Sixth Embodiment

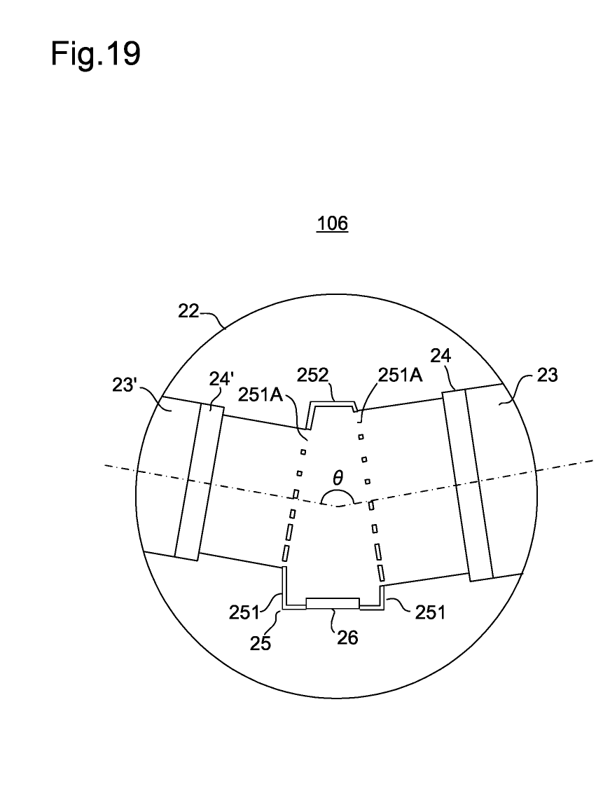

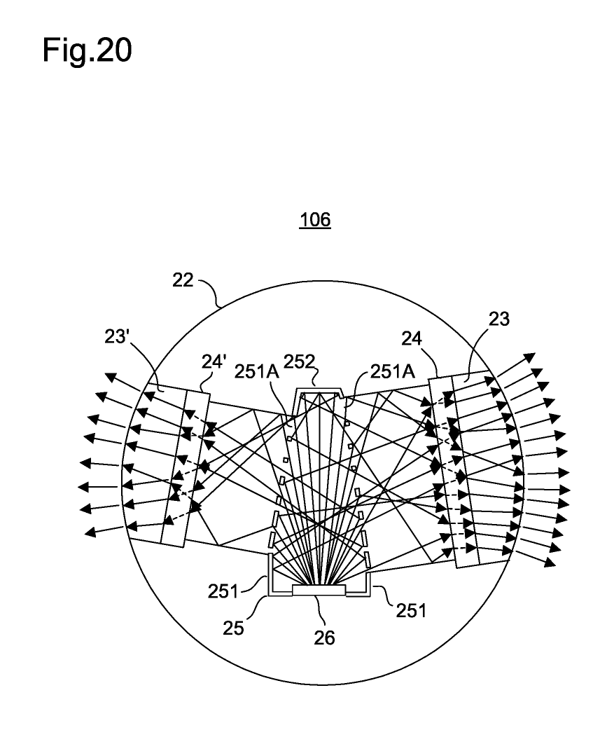

FIG. 19 shows a schematic sectional side view of an illuminant handrail 106 according to a sixth embodiment of the present invention. FIG. 20 shows a schematic sectional side view showing a radiating state of light in the illuminant handrail 106 according to the sixth embodiment of the present invention.

Similarly to the above-described fourth embodiment (FIG. 12, etc.), in the illuminant handrail 106 according to this embodiment, a decorative cover 23 and a light storing material 24 as a combined set and a decorative cover 23′ and a light storing material 24′ as another combined set are fitted into opening portions provided at two locations on a handrail main body 22, respectively, and in a flatter 25, light radiation portions 251 are provided at two locations so as to correspond to these combined sets, respectively.

With respect to the above-described fourth embodiment in which the combined sets each composed of the decorative cover and the light storing material are disposed on the sides 180° opposite to each other, in this embodiment, the decorative covers 23 and 23′ and the light storing materials 24 and 24′ are disposed such that, in a sectional side view, an angle θ (FIG. 19) formed between a center line passing through the combined set of the decorative cover 23 and the light storing material 24 and a center line passing though the combined set of the decorative cover 23′ and the light storing material 24′ is an obtuse angle (90°<θ<180°). The shape and size of the flatter 25 and the size and disposition of a slit 251A provided in each of the light radiation portions 251 are designed in consideration of the sizes and dispositions of the decorative covers 23 and 23′ and the light storing materials 24 and 24′ and the number and dispositions of light sources 26.

With this configuration, as shown in FIG. 20, the light storing materials 24 and 24′ can be irradiated with highly uniform light from the light radiation portions 251 provided at two locations, respectively, and thus light radiated to the outside through the decorative covers 23 and 23′ also can be made highly uniform. Furthermore, light can be stored efficiently in the light storing materials 24 and 24′, and thus as for stored light, uniform radiation thereof can be performed for a long time.

### Seventh Embodiment

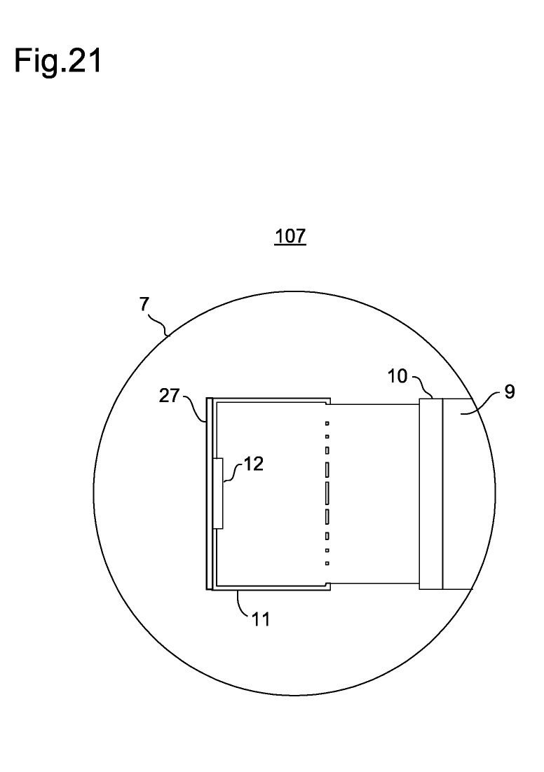

FIG. 21 shows a schematic sectional side view of an illuminant handrail 107 according to a seventh embodiment of the present invention. With respect to the above-described second embodiment (FIG. 7), the illuminant handrail 107 shown in FIG. 21 is configured to further include a wiring board 27 or a reflector 27 to which a light source 12 is fixed.

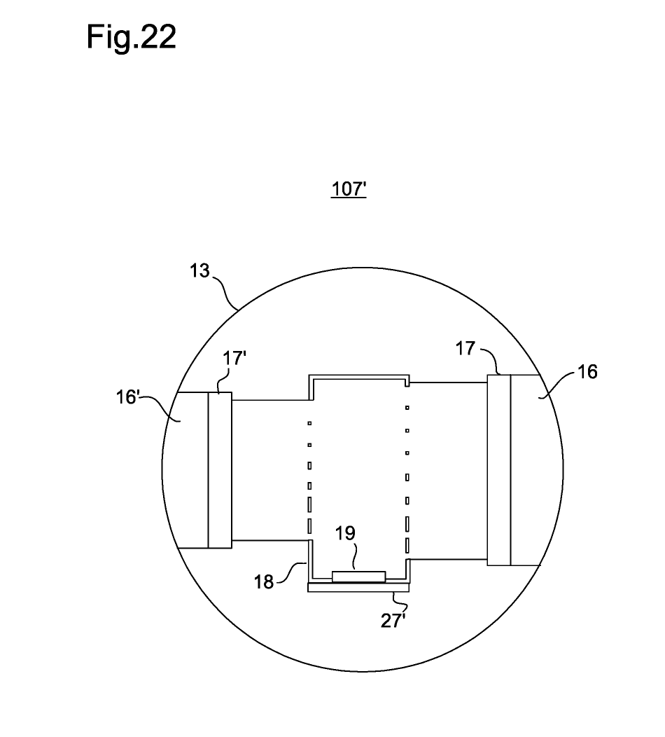

Furthermore, FIG. 22 shows a schematic sectional side view of an illuminant handrail 107′ according to another embodiment based on this embodiment. With respect to the above-described fourth embodiment (FIG. 12), the illuminant handrail 107′ shown in FIG. 22 is configured to further include a wiring board 27′ or a reflector 27′ to which a light source 19 is fixed.

### Eighth Embodiment

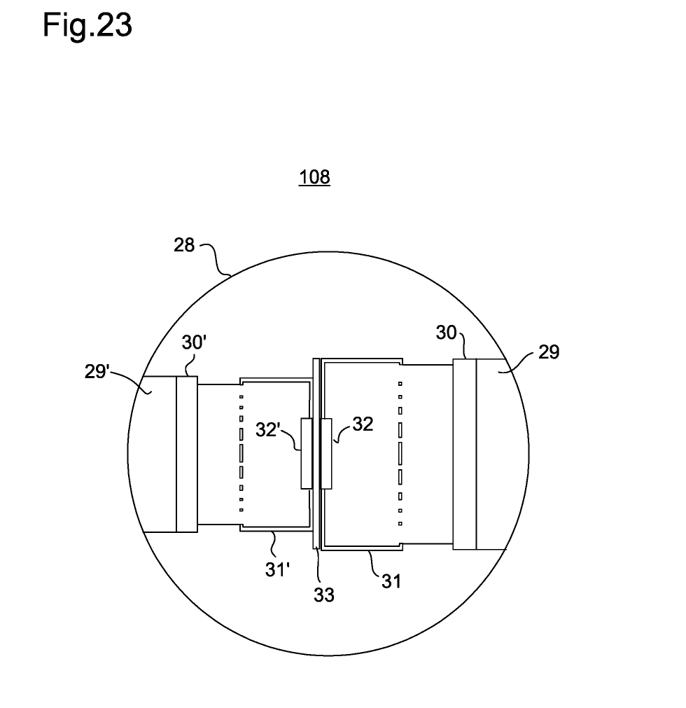

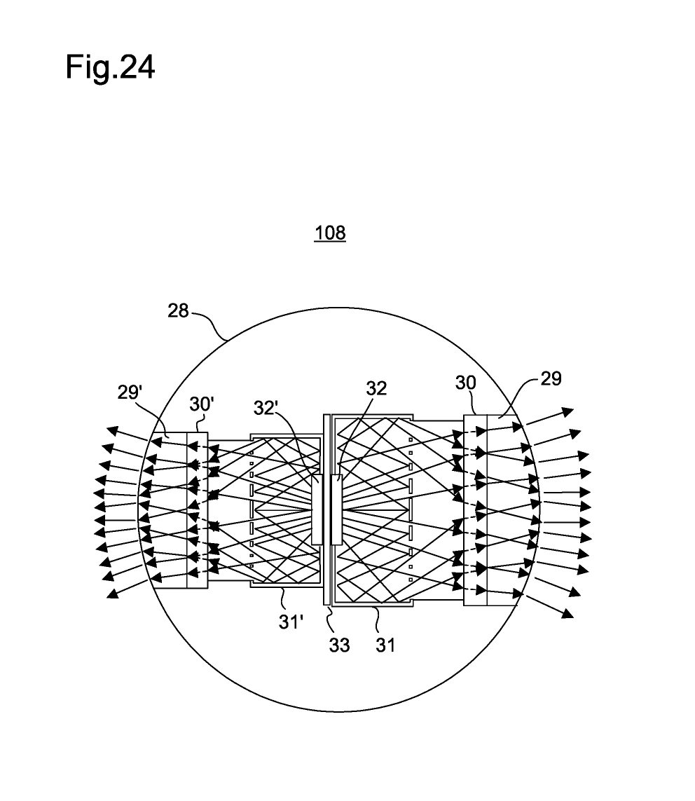

FIG. 23 shows a schematic sectional side view of an illuminant handrail 108 according to an eighth embodiment of the present invention. FIG. 24 shows a schematic sectional side view showing a radiating state of light in the illuminant handrail 108 according to the eighth embodiment of the present invention.

Similarly to the above-described fourth embodiment (FIG. 12), in the illuminant handrail 108 according to this embodiment, a decorative cover 29 and a light storing material 30 as a combined set and a decorative cover 29′ and a light storing material 30′ as another combined set are fitted into opening portions provided at two locations on a handrail main body 28, respectively. In this embodiment, however, with respect to the above-described fourth embodiment in which the light storing materials 17 and 17′ provided at two locations are irradiated by one light source 19, the light storing materials 30 and 30′ are irradiated by two light sources 32 and 32′, respectively.

In this embodiment, there are provided a flatter 31, on an inner side of which the light source 32 on the side of the light storing material 30 is disposed, and a flatter 31′, on an inner side of which the light source 32′ on the side of the light storing material 30′ is disposed. A wiring board 33 is also provided, to both sides of which the light source 32 and the light source 32′ are fixed, respectively.

As shown in FIG. 24, the light storing materials 30 and 30′ can be irradiated with highly uniform light from the flatters 31 and 31′, respectively, and thus light radiated to the outside through the decorative covers 29 and 29′ also can be made highly uniform. Furthermore, light can be stored efficiently in the light storing materials 30 and 30′, and thus as for stored light, uniform radiation thereof can be performed for a long time.

### Ninth Embodiment

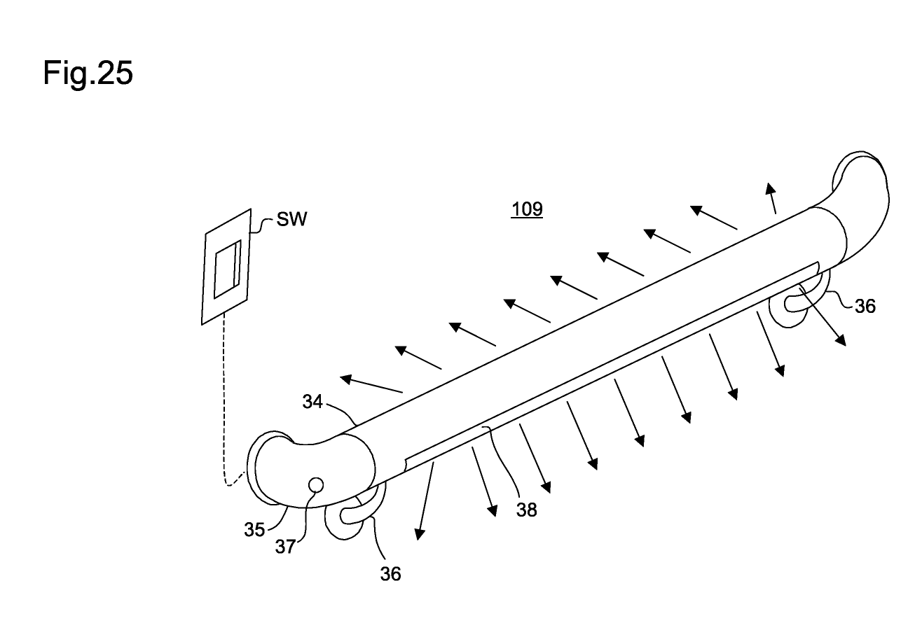

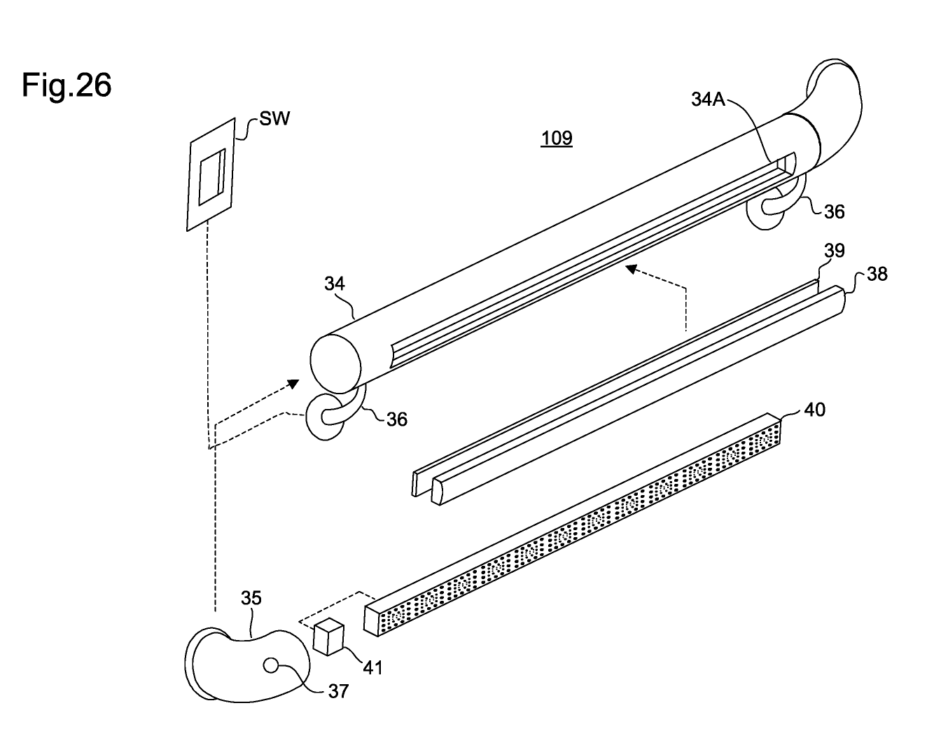

FIG. 25 shows a perspective view of an illuminant handrail 109 according to a ninth embodiment of the present invention. FIG. 26 shows an exploded perspective view of the illuminant handrail 109 according to the ninth embodiment of the present invention.

The illuminant handrail 109 according to this embodiment includes a handrail main body 34, a bracket 35, a handrail main body support portion 36, a human body detection sensor 37, a decorative cover 38, a light storing material 39, a flatter 40, and a timer 41.

The handrail main body 34 is fixedly supported at a lower portion thereof to a wall surface by the handrail main body support portion 36. The decorative cover 38 and the light storing material 39 are fitted into an opening portion 34A provided through the handrail main body 34. After the flatter 40, on an inner side of which a light source (not shown) is disposed, and the timer 41 are inserted into the handrail main body 34, the bracket 35 with the human body detection sensor 37 disposed thereon is mounted to one end portion of the handrail main body 34. The handrail main body 34 is fixedly supported to the wall surface by the bracket 35. Furthermore, an unshown control circuit that performs on/off control of power supply from an illumination switch SW provided on the wall surface to the light source is also provided inside the handrail main body 34. The timer 41 and the control circuit may be provided inside the bracket 35. Furthermore, the human body detection sensor 37 may be provided at the handrail main body support portion 36 or on the handrail main body 34.

As the human body detection sensor 37, for example, an infrared sensor can be used and, preferably, a pyroelectric infrared sensor that is compact and capable of wide-area detection is used, but there is no limitation thereto. An infrared sensor is a sensor that detects variations in infrared rays caused when a human body moves, which has a temperature different from an ambient temperature. Such an infrared sensor (the human body detection sensor 37) is mounted in a state where at least a lens portion thereof on which infrared rays become incident is exposed to the outside from the bracket 35.

The use of an infrared sensor as the human body detection sensor 37 allows detection of a human body in a wide area extending beyond the entire length of the handrail main body 34 (for example, an area within a radius of 5 m), thereby allowing a human body approaching the illuminant handrail 109 to be detected reliably. A sensitivity adjustment circuit may be provided as necessary.

Wiring from each of the human body detection sensor 37, the timer 41, the light source, and the illumination switch SW is electrically connected to the control circuit. When the human body detection sensor 37 detects a human body in a state where the illumination switch SW is on, the control circuit switches power supply from the illumination switch SW to the light source from off to on. This causes the light source to start light emission, and thus highly uniform light is radiated from the flatter 40, so that highly uniform light is radiated to the outside through the light storing material 39 and the decorative cover 38.

At the time when the control circuit switches the power supply from the illumination switch SW to the light source from off to on, the timer 41 starts a time measurement. When the timer 41 has measured a lapse of a fixed length of time, the control circuit switches the power supply from the illumination switch SW to the light source from on to off. This causes the light emission by the light source to be halted. It is assumed herein that the fixed length of time is a length of time required for light to be stored in the light storing material 39. With this configuration, even after light emission by the light source has been halted, light stored in the light storing material 39 is radiated, so that highly uniform irradiation light can be obtained for a long time. Thus, even in a case where power supply from the illumination switch SW to the light source is switched off earlier than necessary for the sake of power saving, the vicinity of the illuminant handrail 109 can be irradiated during a time period in which a pedestrian passes by the illuminant handrail 109.

The following configuration is also possible. That is, at the time when the control circuit switches power supply from the illumination switch SW to the light source from on to off as described above, the timer starts another time measurement, and when a lapse of a fixed length of time has been measured, the control circuit switches the power supply from the illumination switch SW to the light source from off to on. The fixed length of time used in this case is a length of time required for light stored in the light storing material 39 to be lost by radiation. With this configuration, at the time when irradiation with light stored in the light storing material 39 ends, the light source is made to start light emission, and thus continuous irradiation can be achieved.

The following descries modified examples of this embodiment. For example, a decorative cover 38 containing a light storing material may be used without using the light storing material 39, or alternatively, paint containing a light storing material may be applied to a light incidence surface of the decorative cover 38.

Furthermore, in place of the human body detection sensor 37, an illuminance sensor that detects illuminance may be used. In this case, the following operation could be performed. That is, when the illuminance sensor detects that the illuminance has decreased to a level not higher than a predetermined level, the control circuit switches power supply from the illumination switch SW to the light source from off to on, after which control is performed similarly to the above-described manner. With this configuration, when it has become dark in the surroundings, the illuminant handrail can be made to automatically start light emission.

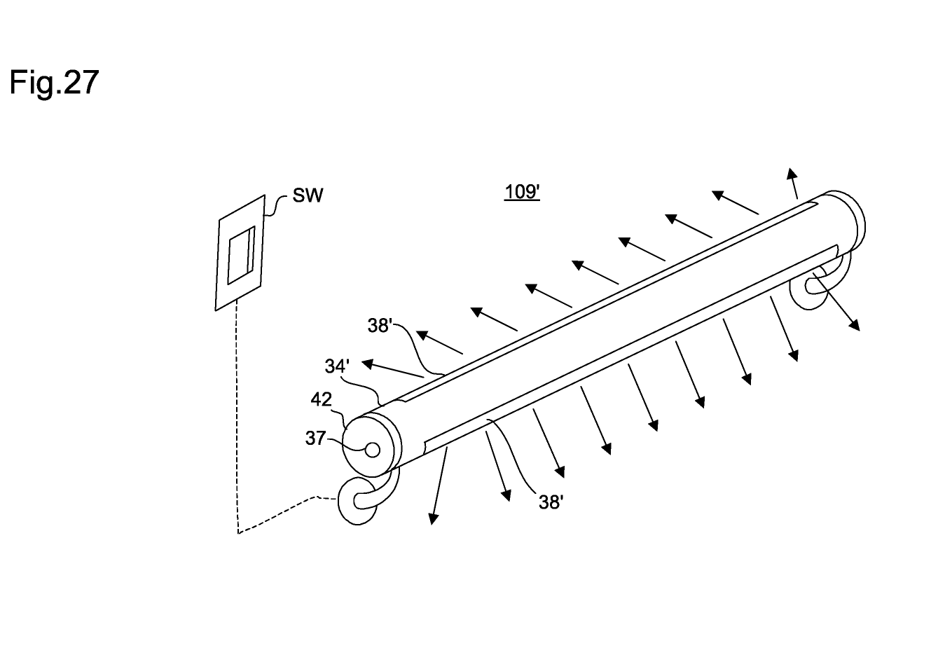

Furthermore, the following configuration is also possible. That is, as shown in FIG. 27, a handrail main body 34′ with a decorative cover 38′ fitted thereinto at each of two locations thereon is used, and the human body detection sensor 37 (or the illuminance sensor) is disposed at an end cap 42 that is mounted to one end portion of the handrail main body 34′.

Furthermore, a light storing function is not necessarily required, and in a case of not having the light storing function, preferably, in the above-described control, a fixed length of time after a human body is detected by the human body detection sensor 37 and thus power supply to the light source is switched from off to on is a length of time sufficient for a pedestrian to pass by the illuminant handrail 109. With this configuration, the vicinity of the illuminant handrail 109 can be irradiated during a time period in which a pedestrian passes by the illuminant handrail 109.

### Tenth Embodiment

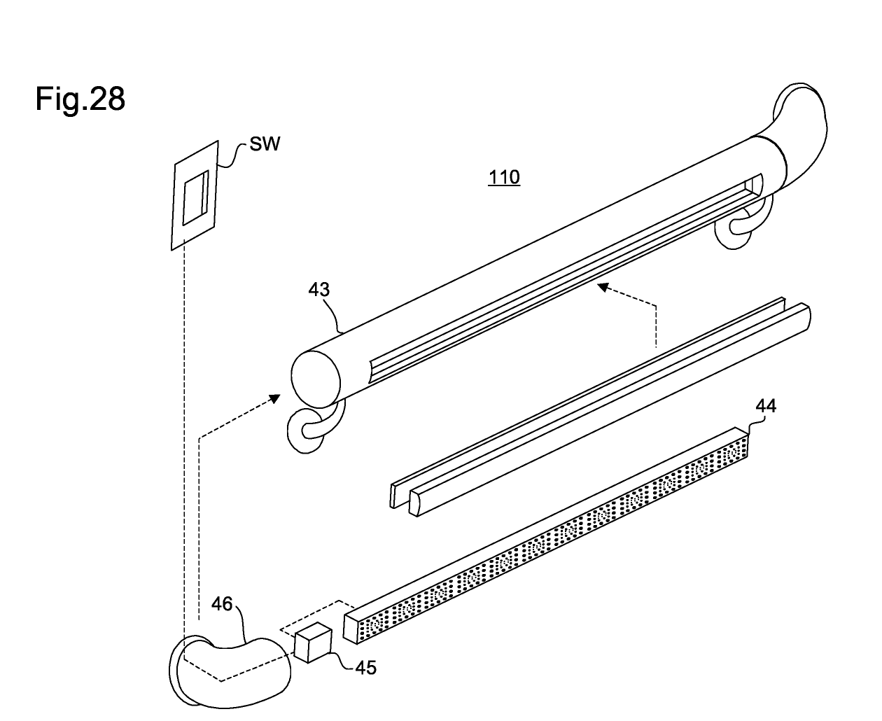

FIG. 28 shows an exploded perspective view of an illuminant handrail 110 according to a tenth embodiment of the present invention. In the illuminant handrail 110 shown in FIG. 28, a power circuit 45 for supplying power to a light source (not shown) disposed on an inner side of a flatter 44 is disposed inside a handrail main body 43 or inside a bracket 46. Wiring from an illumination switch SW is connected to the power circuit 45 through the inside of the bracket 46, and wiring from the power circuit 45 is connected to the light source. When the illumination switch SW is turned on, the power circuit 45 converts alternating current power supplied from the illumination switch SW to direct current power and supplies the direct current power to the light source.

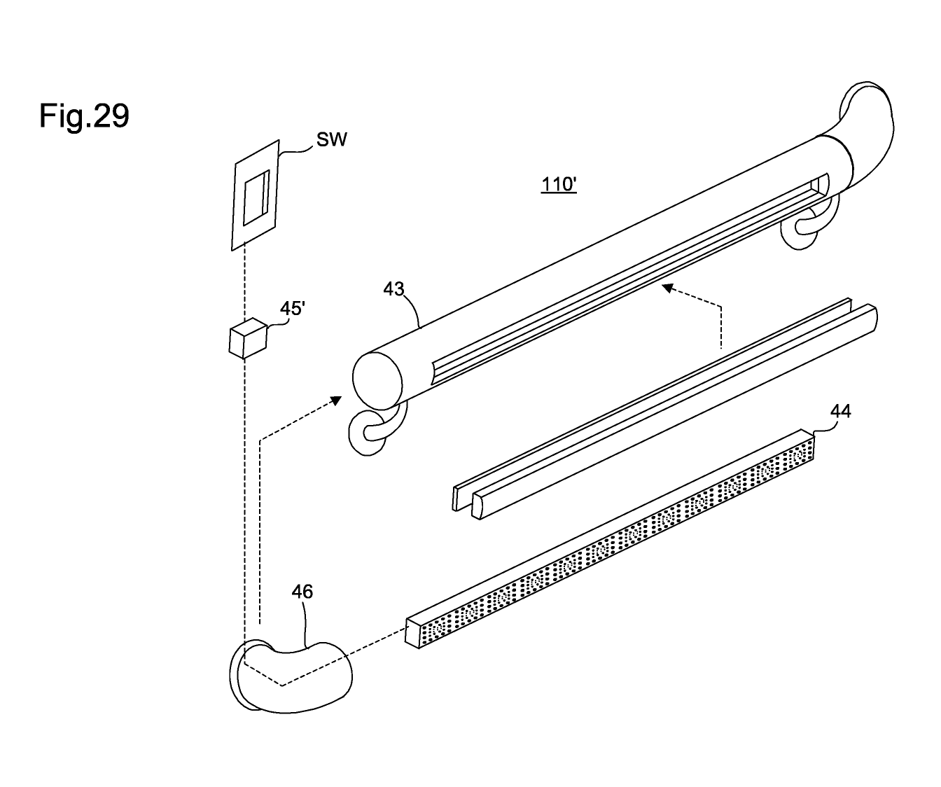

Furthermore, FIG. 29 shows an exploded perspective view of an illuminant handrail 110′ as a modified example of this embodiment. In this modified example, a power unit 45′ including a power circuit for supplying power to the light source is provided on a wall surface on which the illumination switch SW is provided.

### Eleventh Embodiment

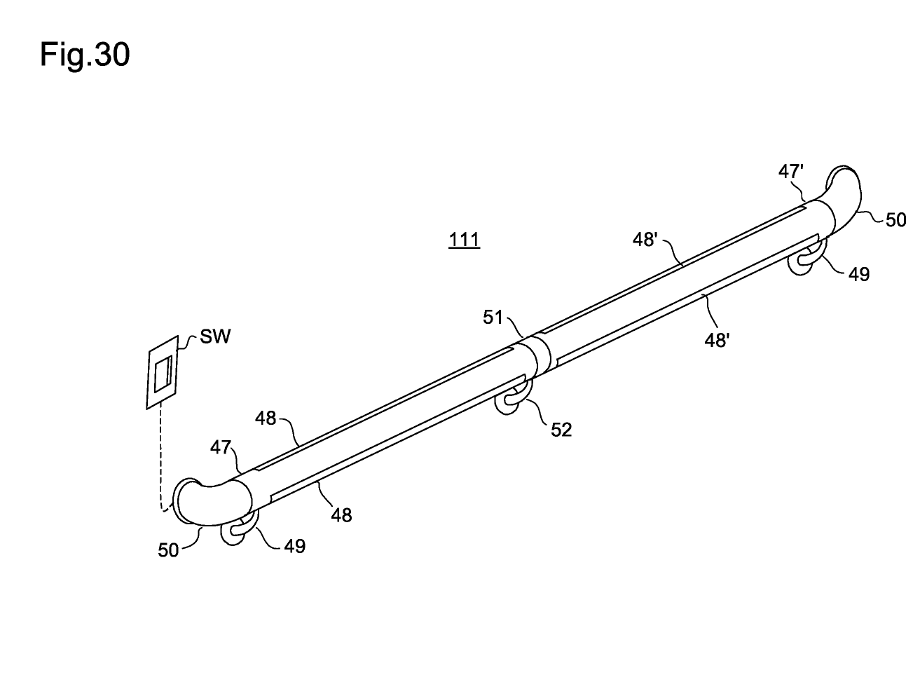

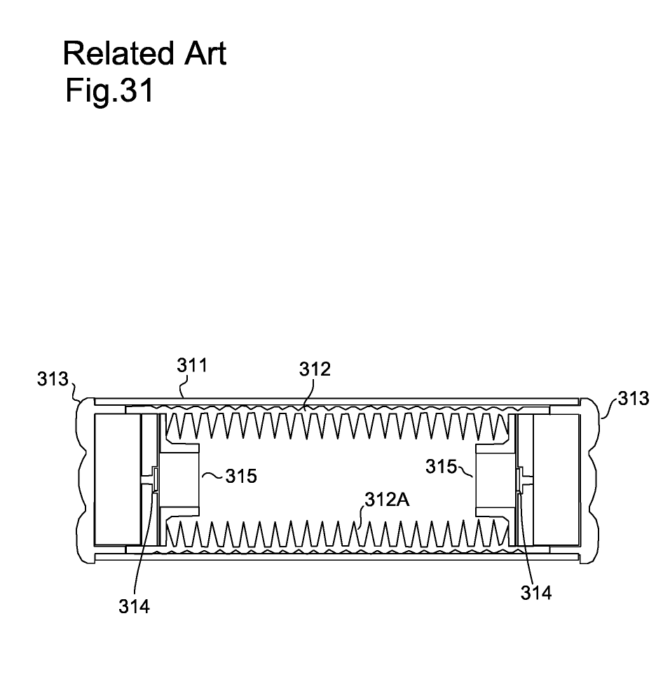

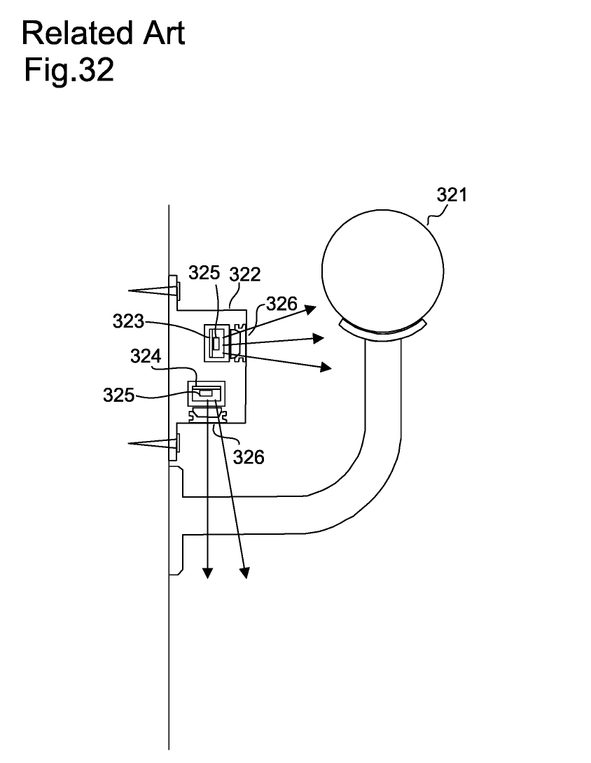

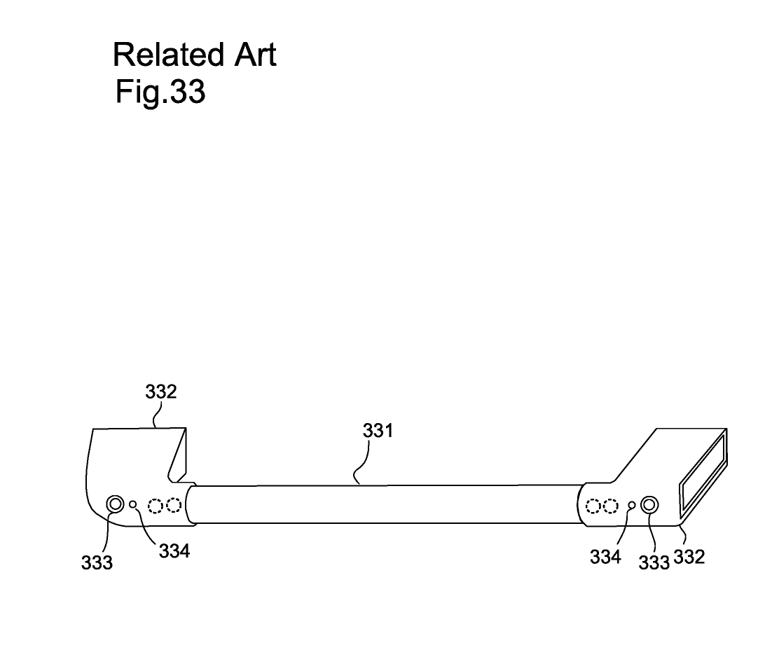

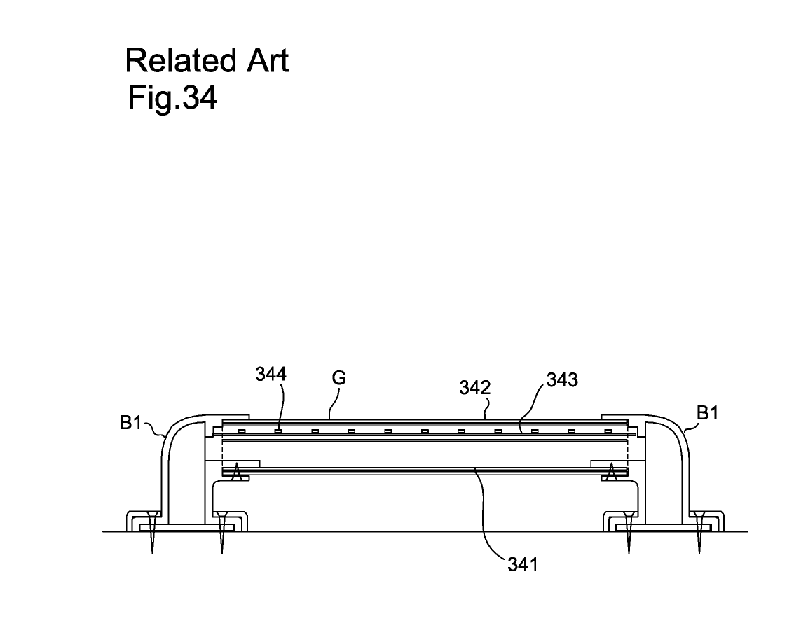

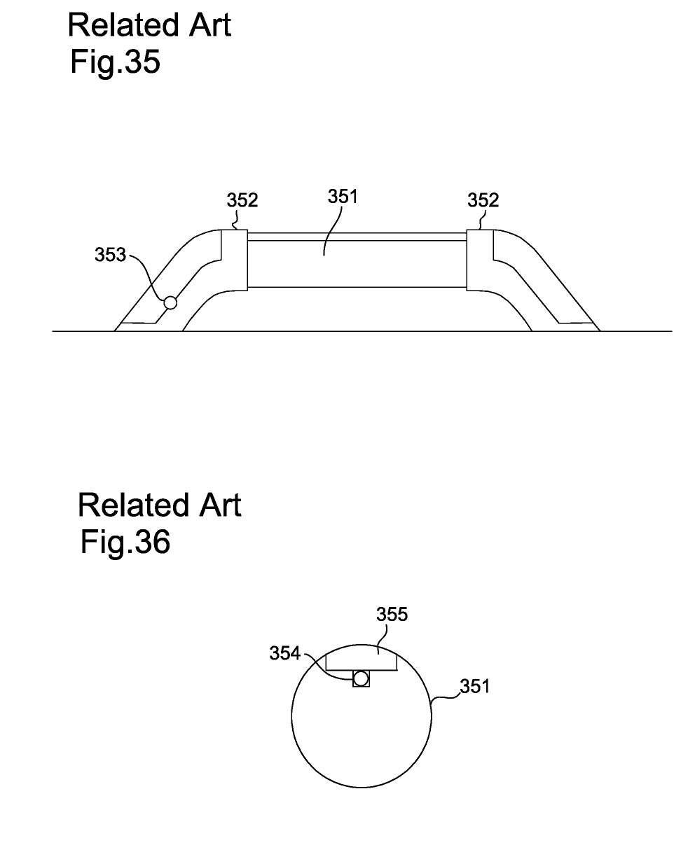

FIG. 30 shows a perspective view of an illuminant handrail 111 according to an eleventh embodiment of the present invention. In the illuminant handrail 111 shown in FIG. 30, a handrail main body 47 with a decorative cover 48 fitted thereinto at each of two locations thereon and a handrail main body 47′ with a decorative cover 48′ fitted thereinto at each of two locations thereon are connected to each other via a handrail connecting bracket 51. A bracket 50 is mounted to one end portion of each of the handrail main bodies 47 and 47′, and thus the handrail main bodies 47 and 47′ are fixedly supported to a wall surface. In addition to that, each of the handrail main bodies 47 and 47′ is fixedly supported at a lower portion of one end portion thereof to the wall surface by a handrail main body support portion 49, and the handrail connecting bracket 51 is fixedly supported at a lower portion thereof to the wall surface by a bracket support portion 52.

A flatter (not shown) with a light source disposed therein is disposed inside each of the handrail main bodies 47 and 47′. Wiring from an illumination switch SW is connected to the light source on the side of the handrail main body 47 through the inside of the bracket 50, and the light source on the side of the handrail main body 47 and the light source on the side of the handrail main body 47′ are electrically connected to each other. With this configuration, when the illumination switch SW is turned on, the light source on the side of the handrail main body 47 and the light source on the side of the handrail main body 47′ emit light, respectively, so that highly uniform irradiation light is radiated from the decorative covers 48 and 48′ to the outside.

A configuration is also possible in which three of more handrail main bodies are connected. Such a configuration according to this embodiment allows a wider range of applications varying depending on an intended use and a place of use.

The embodiments of the present invention discussed in the foregoing may be variously modified without departing from the spirit of the present invention.

For example, the handrail main body may be fixedly supported to a floor surface by a handrail main body support portion or by a bracket.

1. A handrail with an illumination function, comprising:
a handrail main body;
a decorative cover that is disposed at part of the handrail main body so as to extend along a longitudinal direction of the handrail main body and has a light transmitting property;
a flatter that is disposed on an inner side with respect to the decorative cover so as to extend along the longitudinal direction of the handrail main body and reflects and diffuses light to radiate the light through a slit; and
a light source that is disposed on an inner side of the flatter.

2. The handrail with an illumination function according to claim 1, wherein on the inner side with respect to the decorative cover, a light storing material extending along a longitudinal direction of the decorative cover is provided.

3. The handrail with an illumination function according to claim 1, wherein the decorative cover contains a light storing material or paint containing a light storing material is applied to the decorative cover.

4. The handrail with an illumination function according to claim 1, wherein
the decorative cover is disposed at each of a plurality of locations on the handrail main body.

5. The handrail with an illumination function according to claim 4, wherein
a light storing material that is disposed on the inner side with respect to the decorative cover and extends along a longitudinal direction of the decorative cover is disposed at one or each of a plurality of locations.

6. The handrail with an illumination function according to claim 4, wherein
the decorative cover that contains a light storing material or to which paint containing a light storing material is applied is disposed at one or each of a plurality of locations.

7. The handrail with an illumination function according to claim 1, further comprising a wiring board or a reflector to which the light source is fixed.

8. The handrail with an illumination function according to claim 7, wherein
the light source is disposed on one side or each of both sides of the wiring board.

9. The handrail with an illumination function according to claim 1, wherein
the light source is disposed in plurality, and a number of the light sources disposed and a spacing between each pair of adjacent ones of the light sources are determined depending on a size of the decorative cover.

10. The handrail with an illumination function according to claim 1, wherein
the handrail main body has a length in a range of 200 mm to 2000 mm.

11. The handrail with an illumination function according to claim 1, wherein
a shape and a size of the flatter and a size and a disposition of the slit are designed in consideration of a size and a disposition of the decorative cover and a number and dispositions of the light sources used.

12. The handrail with an illumination function according to claim 2, wherein
the light storing material has a thickness in a range of 1 mm to 10 mm.

13. The handrail with an illumination function according to claim 1, wherein
a sensor that detects a human body or a sensor that detects light is disposed at the handrail main body, a bracket that is provided at one end portion of the handrail main body and fixedly supports the handrail main body to a wall surface or a floor surface, or a handrail main body support portion that fixedly supports the handrail main body at a lower portion thereof to a wall surface or a floor surface.

14. The handrail with an illumination function according to claim 13, wherein
a timer is disposed inside the handrail main body or inside the bracket.

15. The handrail with an illumination function according to claim 1, wherein
a power circuit for supplying power to the light source is disposed inside the handrail main body or inside a bracket that is provided at one end portion of the handrail main body and fixedly supports the handrail main body to a wall surface or a floor surface.

16. The handrail with an illumination function according to claim 1, wherein
an external power circuit unit for supplying power to the light source is connectable to the handrail with an illumination function.

17. The handrail with an illumination function according to claim 1, wherein
the light source is an LED light source.

18. The handrail with an illumination function according to claim 1, wherein
a plurality of the handrail main bodies are connected via a bracket.

19. The handrail with an illumination function according to claim 5, wherein
the light storing material has a thickness in a range of 1 mm to 10 mm.
